(19) United States
(12) Patent Application Publication
(10) Pub. No.: US 2020/0126049 A1
(43) Pub. Date: Apr. 23, 2020

(54) FUND FLOW METHOD AND APPARATUS, AND ELECTRONIC DEVICE

(71) Applicant: Alibaba Group Holding Limited, George Town (KY)

(72) Inventors: Danqing Hu, Hanzghou (CN); Xuebing Yan, Hangzhou (CN)

(73) Assignee: Alibaba Group Holding Limited, George Town (KY)

(21) Appl. No.: 16/722,929

(22) Filed: Dec. 20, 2019

Related U.S. Application Data
(63) Continuation of application No. 16/251,501, filed on Jan. 18, 2019.

(30) Foreign Application Priority Data
Jan. 19, 2018 (CN) 201810055551.6

(51) Int. Cl. G06Q 20/06; G06Q 20/36; G06Q 20/40; H04L 9/06; H04L 9/32

(52) U.S. Cl. CPC G06Q 20/0658; G06Q 20/3672; G06Q 20/4037; H04L 2209/38; H04L 9/3239; H04L 2209/56; H04L 9/0637

(57) ABSTRACT

A request for fund flow of a specified amount between a payer and a payee is received by a first member of a blockchain. A fund flow route between the first member and a second member corresponding to the payee in the blockchain is determined by the first member, where the fund flow route comprises the first member, the second member, and several relay members, and blockchain balances deposited by all members of the fund flow route at all anchor points of the blockchain are registered in a blockchain ledger of the blockchain. A fund flow contract operation is initiated by the first member. In response to initiating the fund flow contract operation, the blockchain balances of all the members of the fund flow route registered in the blockchain ledger are uniformly changed, where the second member pays funds of the specified amount to the payee.

### CROSS-REFERENCE TO RELATED APPLICATIONS

This application claims priority to U.S. application Ser. No. 16/251,501, filed on Jan. 18, 2019, which claims priority to Chinese Patent Application No. 201810055551.6, filed on Jan. 19, 2018, which are hereby incorporated by reference in its entirety.

### TECHNICAL FIELD

One or more implementations of the present specification relate to the field of blockchain technologies, and in particular, to a fund flow method and apparatus, and an electronic device.

### BACKGROUND

Fund flow scenario can happen between users, between a user and an enterprise, between enterprises, etc. in related technologies. Users or enterprises that pay funds serve as payers, and users or enterprises that receive funds serve as payees, to implement fund flow between the payers and the payees.

When fund flow between a payer and a payee involves multiple financial institutions, the payer first provides funds to a first financial institution, and the funds need to be successively transferred between the financial institutions, and eventually paid to the payee.

### SUMMARY

One or more implementations of the present specification provide a fund flow method and apparatus, and an electronic device.

To achieve the objective above, one or more implementations of the present specification provide the following technical solutions:

According to a first aspect of one or more implementations of the present specification, a fund flow method is provided, including the following: receiving, by a first member of a blockchain, a request for fund flow of a specified amount between a payer and a payee; determining, by the first member, a fund flow route between the first member and a second member corresponding to the payee in the blockchain, where the fund flow route includes the first member, the second member, and several relay members, and blockchain balances deposited by all members of the fund flow route at all anchor points of the blockchain are registered in a blockchain ledger of the blockchain; and initiating, by the first member, a fund flow contract operation, where after the fund flow contract operation takes effect, the blockchain balances of all the members of the fund flow route registered in the blockchain ledger uniformly change, so that the second member pays the specified amount to the payee.

According to a second aspect of one or more implementations of the present specification, a fund flow method is provided, including the following: receiving, by a first member of a blockchain, a request for fund flow of a specified amount between a payer and a payee; determining, by the first member, a fund flow route between the first member and a second member corresponding to the payee in the blockchain, where the fund flow route includes the first member and the second member, and blockchain balances deposited by all members of the fund flow route at all anchor points of the blockchain are registered in a blockchain ledger of the blockchain; and initiating, by the first member, a fund flow contract operation, where after the fund flow contract operation takes effect, the blockchain balances of all the members of the fund flow route registered in the blockchain ledger uniformly change, so that the second member pays the specified amount to the payee.

According to a third aspect of one or more implementations of the present specification, a fund flow apparatus is provided, including the following: a request receiving unit, configured to enable a first member of a blockchain to receive a request for fund flow of a specified amount between a payer and a payee; a route determining unit, configured to enable the first member to determine a fund flow route between the first member and a second member corresponding to the payee in the blockchain, where the fund flow route includes the first member, the second member, and several relay members, and blockchain balances deposited by all members of the fund flow route at all anchor points of the blockchain are registered in a blockchain ledger of the blockchain; and an operation initiation unit, configured to enable the first member to initiate a fund flow contract operation, where after the fund flow contract operation takes effect, the blockchain balances of all the members of the fund flow route registered in the blockchain ledger uniformly change, so that the second member pays the specified amount to the payee.

According to a fourth aspect of one or more implementations of the present specification, a fund flow apparatus is provided, including the following: a request receiving unit, configured to enable a first member of a blockchain to receive a request for fund flow of a specified amount between a payer and a payee; a route determining unit, configured to enable the first member to determine a fund flow route between the first member and a second member corresponding to the payee in the blockchain, where the fund flow route includes the first member and the second member, and blockchain balances deposited by all members of the fund flow route at all anchor points of the blockchain are registered in a blockchain ledger of the blockchain; and an operation initiation unit, configured to enable the first member to initiate a fund flow contract operation, where after the fund flow contract operation takes effect, the blockchain balances of all the members of the fund flow route registered in the blockchain ledger uniformly change, so that the second member pays the specified amount to the payee.

According to a fifth aspect of one or more implementations of the present specification, an electronic device is provided, including the following: a processor; and memory, configured to store an executable instruction of the processor, where the processor is configured to implement the fund flow method according to any one of the implementations.

### BRIEF DESCRIPTION OF DRAWINGS

FIG. 1A is a flowchart illustrating a fund flow method, according to an example implementation;

FIG. 1B is a flowchart illustrating another fund flow method, according to an example implementation;

FIG. 2 is a schematic diagram illustrating a remittance scenario, according to an example implementation;

FIG. 3 is a schematic diagram illustrating interaction in a cross-border remittance process, according to an example implementation;

FIG. 4 is a schematic diagram illustrating a scenario that Wallet 1 receives remittance fund provided by user 1, according to an example implementation;

FIG. 5 is a schematic diagram illustrating determination of a remittance route, according to an example implementation;

FIG. 6 is a schematic diagram illustrating implementation of fund flow between members in a remittance route, according to an example implementation;

FIG. 7 is a schematic diagram illustrating a scenario that Wallet 2 provides user 2 with remittance fund, according to an example implementation;

FIG. 8 is a schematic diagram illustrating remittance that remittance funds are transferred to a blockchain balance, according to an example implementation;

FIG. 9 is a schematic diagram illustrating credit-based remittance, according to an example implementation;

FIG. 10 is a schematic diagram illustrating transaction information generated during fund settlement, according to an example implementation;

FIG. 11 is a schematic diagram illustrating water level recovery during fund settlement, according to an example implementation;

FIG. 12 is a schematic diagram illustrating water level adjustment based on historical change data during fund settlement, according to an example implementation;

FIG. 13 is a schematic diagram illustrating water level adjustment based on fund flow prediction data during fund settlement, according to an example implementation;

FIG. 14 is a schematic structural diagram illustrating a device, according to an example implementation;

FIG. 15 is a block diagram illustrating a fund flow apparatus, according to an example implementation;

FIG. 16 is a block diagram illustrating another fund flow apparatus, according to an example implementation; and

FIG. 17 is a flowchart illustrating an example of a computer-implemented method for a fund flow, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations that are consistent with one or more implementations of the present specification. On the contrary, the implementations are only examples of apparatuses and methods that are described in the appended claims in detail and consistent with some aspects of one or more implementations of the present specification.

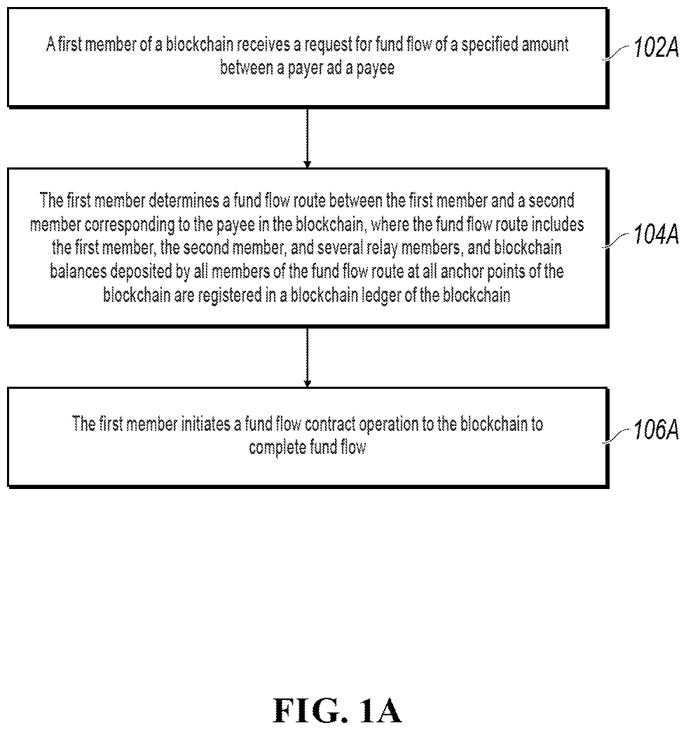

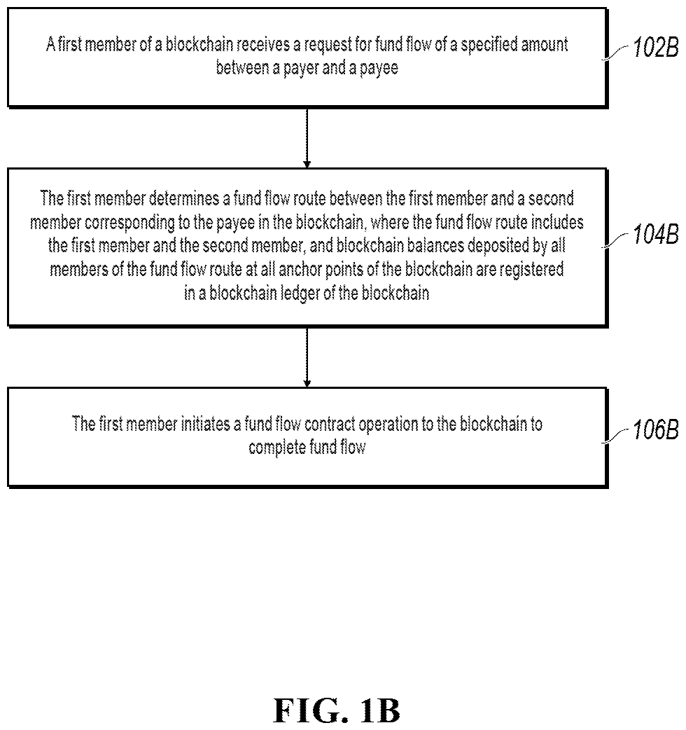

FIG. 1A is a flowchart illustrating a fund flow method, according to an example implementation. As shown in FIG. 1A, the method can include the following steps.

Step 102A: A first member of a blockchain receives a request for fund flow of a specified amount between a payer and a payee.

In an implementation, a fund payment request can be initiated by the payer for the payee. In other words, the request for fund flow received by the first member can be the fund payment request. For example, the fund payment request can be used by the payer to remit or pay fund to the payee, which is not limited in the present specification.

In an implementation, a fund receiving request can be initiated by the payee for the payer. In other words, the request for fund flow received by the first member can be the fund receiving request. For example, the fund receiving request can be used by the payee to receive fund from the payer, which is not limited in the present specification.

In an implementation, the payer and the payee can be individuals or organizations (such as enterprises or platforms), which is not limited in the present specification.

Step 104A: The first member determines a fund flow route between the first member and a second member corresponding to the payee in the blockchain, where the fund flow route includes the first member, the second member, and several relay members, and blockchain balances deposited by all members of the fund flow route at all anchor points of the blockchain are registered in a blockchain ledger of the blockchain.

In an implementation, information about the first member, the second member, and the relay member in the fund flow route and information about other members not in the fund flow route can be stored in the blockchain, and these members can be nodes on the blockchain. The nodes on the blockchain can further include several anchor points. Roles of these anchor points can but not are necessarily to be played by the members.

In an implementation, members of the fund flow route can be financial institutions that support a fund flow service, organizations or platforms in other forms, etc., which is not limited in the present specification. A financial institution is used as an example. All the members in the fund flow route can belong to different institutions (for example, multiple banks), or can belong to different branches of the same institution (for example, multiple branches of the same bank), which is not limited in the present specification.

In an implementation, each member in the blockchain can deposit a blockchain balance of a specific amount at each anchor point, and each anchor point is responsible for registering the blockchain balance deposited by each member at each anchor point on the blockchain. Information recorded by the anchor point can be broadcast to all other nodes for storage. When any change occurs in the blockchain balance, the anchor point records corresponding change information to a block and broadcasts the information to all other nodes. The blockchain uses a distributed ledger technology, and all nodes store full ledger information. In addition, all the nodes of the blockchain can reach an agreement by using a consensus algorithm, thereby jointly maintaining a unified ledger, namely, the blockchain ledger. Therefore, when a certain member or anchor point in the present specification reads or records information for the “blockchain ledger”, the member or the anchor point performs information reading or recording based on the full ledger information stored by the member or the anchor point.

In an implementation, an associated anchor point exists between adjacent members in the fund flow route. A blockchain balance deposited by an upstream member in the adjacent members at the associated anchor point is greater than the specified amount, to ensure that the blockchain balance is sufficient for fund that needs to be transferred. In addition, the associated anchor point is set as a trusted anchor point by a downstream member, to ensure that the downstream member is capable of or willing to receive funds at the associated anchor point.

In an implementation, several members of the blockchain participate in a smart contract (contract for short) for a fund flow service and authorize the contract so that these members can implement the fund flow service based on the contract. The contract records information about these members, for example, a status of trustiness imposed by each member in each anchor point, so that a trusted anchor point, an untrusted anchor point, etc. corresponding to each member can be accordingly determined. Because a blockchain balance deposited by each member at each anchor point is registered in the blockchain ledger, it can be determined whether a blockchain balance deposited by a certain member at a certain anchor point is greater than the specified amount. When a certain member does not deposit a blockchain balance at a corresponding trusted anchor point or a blockchain balance is exhausted, it can be considered that the blockchain balance of the member is 0. Therefore, the first member can initiate a route selection contract operation. After the route selection contract operation takes effect, all adjacent members satisfying the condition “a blockchain balance deposited by an upstream member at the associated anchor point is greater than the specified amount, and the associated anchor point is set as a trusted anchor point by a downstream member” can be determined, to form the fund flow route. In other words, the fund flow route is determined based on the status of trustiness imposed by each member in each anchor point and a deposit status of a blockchain balance of each member at each anchor point registered in the blockchain ledger.

In an implementation, after a fund flow contract operation takes effect, the blockchain balance deposited by the upstream member in the adjacent members at the associated anchor point is reduced by the specified amount, and a blockchain balance deposited by the downstream member at the associated anchor point is increased by the specified amount. In addition, all adjacent members encounter the blockchain balance changes at corresponding associated anchor points, so that the blockchain balances of all the members of the fund flow route registered in the blockchain ledger uniformly change. The first member serves as the most upstream member in the fund flow route, and a blockchain balance at a corresponding associated anchor point is reduced by the specified amount. The second member serves as the most downstream member in the fund flow route, and a blockchain balance at a corresponding associated anchor point is increased by the specified amount. In addition, each relay member serves as both an upstream member and a downstream member. When the relay member serves as an upstream member, a blockchain balance at a corresponding associated anchor point is reduced by the specified amount; and when the relay member serves as a downstream member, a blockchain balance at a corresponding associated anchor point is increased by the specified amount. In other words, a net change amount of the blockchain balance of the relay member at all anchor points is 0. Therefore, it finally shows that the specified amount is transferred from the blockchain balance of the first member to the blockchain balance of the second member.

Step 106A: The first member initiates a fund flow contract operation to complete fund flow.

In an implementation, the first member initiates the fund flow contract operation. After the fund flow contract operation takes effect, the blockchain balances of all the members of the fund flow route registered in the blockchain ledger uniformly change. Therefore, the specified amount is transferred from the blockchain balance of the first member to the blockchain balance of the second member through the fund flow route, so that the second member pays fund of the specified amount to the payee.

In an implementation, a unified blockchain ledger is used in the blockchain, and the blockchain balances respectively deposited by all the members at all the anchor points are registered in the blockchain ledger. Therefore, after the first member initiates a contract operation, the blockchain balances of all the members in the fund flow route can uniformly change based on the contract operation, without performing serial flow between members, thereby improving fund flow efficiency and making real-time, quasi real-time, or nearly real-time fund flow possible. Data registered in the blockchain has a tamper-resistance feature so that blockchain balance information uniformly registered in the blockchain ledger can be trusted by each member and is sufficiently reliable. A contract operation on the blockchain can be used to coordinate multiple different institutions to complete the same service, so that each member is willing to implement the high-efficient fund flow based on the blockchain ledger.

In an implementation, the fund flow solution of the present specification can be applied to various fund flow scenarios, such as domestic fund flow and cross-border fund flow, which is not limited in the present specification. Cross-border fund flow usually involves a relatively large quantity of members. Therefore, the fund flow solution of the present specification can improve fund flow efficiency more significantly.

In an implementation, the blockchain involved in the present specification can be a consortium chain, and each member in the fund flow route is a member of the consortium chain. In addition, the consortium chain can further include more members, which is not limited in the present specification.

In an implementation, the first member can obtain the fund of the specified amount provided by the payer, deposit the fund of the specified amount in the blockchain balance of the first member, and initiate the fund flow contract operation, so that the funds provided by the payer are directly involved in fund flow.

In an implementation, the first member can obtain the fund of the specified amount provided by the payer, deposit the fund of the specified amount in a self-owned account of the first member, and initiate the fund flow contract operation, so that the fund provided by the payer are not directly involved in fund flow, but be replaced by a blockchain balance of the first member. In addition, a net change amount between the self-owned account and the blockchain balance of the first member is 0 and no loss occurs.

In an implementation, before obtaining the fund of the specified amount provided by the payer, the first member can initiate the fund flow contract operation based on credit of the payer. In other words, the payer does not need to immediately pay corresponding funds. Instead, the first member can perform, based on the credit, advance payment on funds that need to be paid by the payer.

In an implementation, after a blockchain balance of the second member is increased by the fund of the specified amount, the second member can directly withdraw fund of the specified amount from the blockchain balance and provide the payee with the fund of the specified amount. In another implementation, the second member can withdraw fund of the specified amount from a self-owned account and provide the payee with the fund of the specified amount. In addition, a net change amount between the self-owned account and the blockchain balance of the second member is 0 and no loss occurs.

In an implementation, the first member and the second member can separately use any above-mentioned processing solution, and no necessary association exists between the processing solutions used by the first member and the second member, which is not limited in the present specification.

FIG. 1B is a flowchart illustrating another fund flow method, according to an example implementation. As shown in FIG. 1B, the method can include the following steps.

Step 102B: A first member of a blockchain receives a request for fund flow of a specified amount between a payer and a payee.

In an implementation, a fund payment request can be initiated by the payer for the payee. In other words, the request for fund flow received by the first member can be the fund payment request. For example, the fund payment request can be used by the payer to remit or pay funds to the payee, which is not limited in the present specification.

In an implementation, a fund receiving request can be initiated by the payee for the payer. In other words, the request for fund flow received by the first member can be the fund receiving request. For example, the fund receiving request can be used by the payee to receive funds from the payer, which is not limited in the present specification.

In an implementation, the payer and the payee can be individuals or organizations (such as enterprises or platforms), which is not limited in the present specification.

Step 104B: The first member determines a fund flow route between the first member and a second member corresponding to the payee in the blockchain, where the fund flow route includes the first member and the second member, and blockchain balances deposited by all members of the fund flow route at all anchor points of the blockchain are registered in a blockchain ledger of the blockchain.

In an implementation, information about the first member and the second member in the fund flow route and information about other members not in the fund flow route can be stored in the blockchain, and these members can be nodes on the blockchain. The nodes on the blockchain can further include several anchor points. Roles of these anchor points can but not necessarily be played by the members.

In an implementation, members of the fund flow route can be financial institutions that support a fund flow service, organizations or platforms in other forms, etc., which is not limited in the present specification. A financial institution is used as an example. All the members in the fund flow route can belong to different institutions (for example, multiple banks), or can belong to different branches of the same institution (for example, multiple branches of the same bank), which is not limited in the present specification.

In an implementation, each member in the blockchain can deposit a blockchain balance of a specific amount at each anchor point, and each anchor point is responsible for registering the blockchain balance deposited by each member at each anchor point on the blockchain. Information recorded by the anchor point can be broadcast to all other nodes for storage. When any change occurs in the blockchain balance, the anchor point records corresponding change information to a block and broadcasts the information to all other nodes. The blockchain uses a distributed ledger technology, and all nodes store full ledger information. In addition, all the nodes of the blockchain can reach an agreement by using a consensus algorithm, thereby jointly maintaining a unified ledger, namely, the blockchain ledger. Therefore, when a certain member or anchor point in the present specification reads or records information for the “blockchain ledger”, the member or the anchor point performs information reading or recording based on the full ledger information stored by the member or the anchor point.

In an implementation, an associated anchor point exists between adjacent members in the fund flow route. A blockchain balance deposited by an upstream member in the adjacent members at the associated anchor point is greater than the specified amount, to ensure that the blockchain balance is sufficient for funds that need to be transferred. In addition, the associated anchor point is set as a trusted anchor point by a downstream member, to ensure that the downstream member is capable of or willing to receive funds at the associated anchor point.

In an implementation, several members of the blockchain participate in a smart contract (contract for short) for a fund flow service and authorize the contract so that these members can implement the fund flow service based on the contract. The contract records information about these members, for example, a status of trustiness imposed by each member in each anchor point, so that a trusted anchor point, an untrusted anchor point, etc. corresponding to each member can be accordingly determined. Because a blockchain balance deposited by each member at each anchor point is registered in the blockchain ledger, it can be determined whether a blockchain balance deposited by a certain member at a certain anchor point is greater than the specified amount. When a certain member does not deposit a blockchain balance at a corresponding trusted anchor point or a blockchain balance is exhausted, it can be considered that the blockchain balance of the member is 0. Therefore, the first member can initiate a route selection contract operation. After the route selection contract operation takes effect, the second member satisfying the condition “a blockchain balance deposited by an upstream member at the associated anchor point is greater than the specified amount, and the associated anchor point is set as a trusted anchor point by a downstream member” can be determined, to form the fund flow route. In other words, the fund flow route is determined based on the status of trustiness imposed by each member in each anchor point and a deposit status of a blockchain balance of each member at each anchor point registered in the blockchain ledger.

In an implementation, after a fund flow contract operation takes effect, a blockchain balance deposited by the first member at the associated anchor point is reduced by the specified amount, and a blockchain balance deposited by the second member at the associated anchor point is increased by the specified amount, so that the blockchain balances of all the members of the fund flow route registered in the blockchain ledger uniformly change. Therefore, it finally shows that the specified amount is transferred from the blockchain balance of the first member to the blockchain balance of the second member.

Step 106B: The first member initiates a fund flow contract operation, where after the fund flow contract operation takes effect, the blockchain balances of all the members of the fund flow route registered in the blockchain ledger uniformly change, so that the second member pays fund of the specified amount to the payee.

In an implementation, the first member initiates the fund flow contract operation. After the fund flow contract operation takes effect, the blockchain balances of all the members of the fund flow route registered in the blockchain ledger uniformly change. Therefore, the specified amount is transferred from the blockchain balance of the first member to the blockchain balance of the second member, so that the second member pays fund of the specified amount to the payee.

In an implementation, data registered in the blockchain has a tamper-resistance feature, so that blockchain balance information uniformly registered in the blockchain ledger can be trusted by each member and is sufficiently reliable. A contract operation on the blockchain can be used to coordinate multiple different institutions to complete the same service, so that each member is willing to implement the high-efficient fund flow based on the blockchain ledger.

In an implementation, the fund flow solution of the present specification can be applied to various fund flow scenarios, such as domestic fund flow and cross-border fund flow, which is not limited in the present specification. Cross-border fund flow usually involves a relatively large quantity of members. Therefore, the fund flow solution of the present specification can further improve fund flow efficiency more significantly.

In an implementation, the blockchain involved in the present specification can be a consortium chain, and each member in the fund flow route is a member of the consortium chain. In addition, the consortium chain can further include more other consortium members, which is not limited in the present specification.

In an implementation, the first member can obtain the funds of the specified amount provided by the payer, deposit the funds of the specified amount in the blockchain balance of the first member, and initiate the fund flow contract operation, so that the funds provided by the payer are directly involved in fund flow.

In an implementation, the first member can obtain the funds of the specified amount provided by the payer, deposit the funds of the specified amount in a self-owned account of the first member, and initiate the fund flow contract operation, so that the funds provided by the payer are not directly involved in fund flow, but be replaced by a blockchain balance of the first member. In addition, a net change amount between the self-owned account and the blockchain balance of the first member is 0 and no loss occurs.

In an implementation, before obtaining the funds of the specified amount provided by the payer, the first member can initiate the fund flow contract operation based on credit of the payer. In other words, the payer does not need to immediately pay corresponding funds. Instead, the first member can perform, based on the credit, advance payment on funds that need to be paid by the payer.

In an implementation, after a blockchain balance of the second member is increased by the funds of the specified amount, the second member can directly withdraw funds of the specified amount from the blockchain balance and provide the payee with the funds of the specified amount. In another implementation, the second member can withdraw funds of the specified amount from a self-owned account and provide the payee with the funds of the specified amount. In addition, a net change amount between the self-owned account and the blockchain balance of the second member is 0 and no loss occurs.

In an implementation, the first member and the second member can separately use any above-mentioned processing solution, and no necessary association exists between the processing solutions used by the first member and the second member, which is not limited in the present specification.

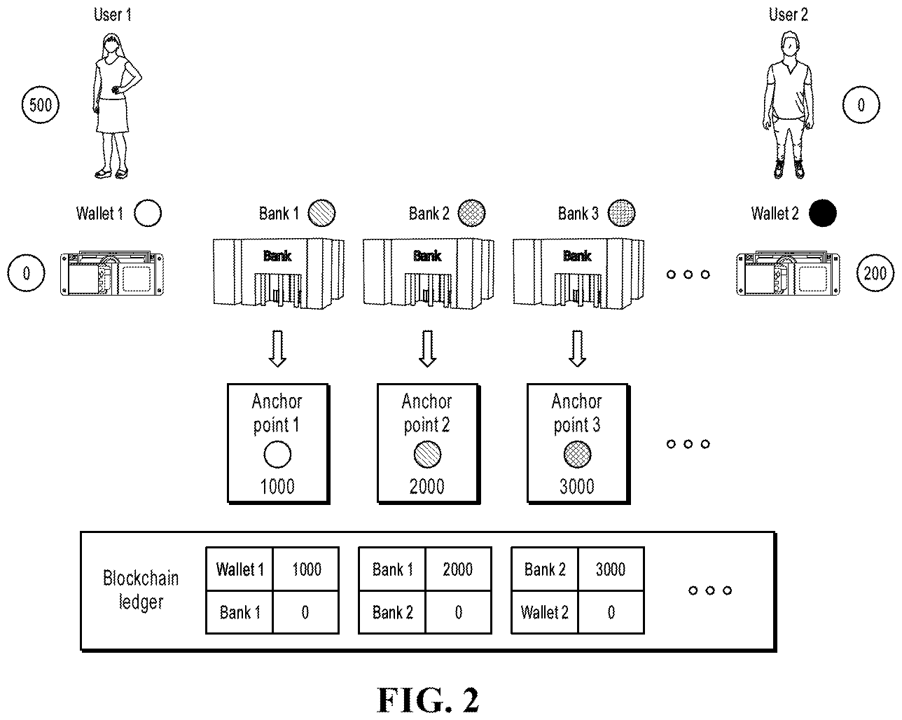

For ease of understanding, a “cross-border remittance” process is used as an example below to describe technical solutions of one or more implementations of the present specification. FIG. 2 is a schematic diagram illustrating a remittance scenario, according to an example implementation. As shown in FIG. 2, assume that a third-party payment platform operates Wallet 1 in country A and Wallet 2 in country B. User 1 in country A has customer fund account 1 in Wallet 1, and user 2 in country B has customer fund account 2 in Wallet 2. The fund flow solution of the present specification can implement fast cross-border remittance between user 1 and user 2.

In an implementation, assume that Wallet 1, Wallet 2, Bank 1, Bank 2, Bank 3, etc. shown in FIG. 2 all are members (member) of the same blockchain, and the blockchain can include several anchor points such as anchor point 1, anchor point 2, and anchor point 3 shown in FIG. 2. A role of an anchor point can be played by a member. For example, anchor point 1 to anchor point 3 in FIG. 2 respectively correspond to Bank 1 to Bank 3. Certainly, a member may not play the role of an anchor point, and an anchor point is not necessarily a member. In other words, no necessary one-to-one mapping relationship exists between a member and an anchor point. Members such as Wallet 1, Wallet 2, and Bank 1 to Bank 3, anchor point 1 to anchor point 3, etc. all are nodes in the blockchain, and these nodes implement distributed ledger technology in the blockchain.

To implement remittance between user 1 and user 2 by using the members in the blockchain, Wallet 1, Wallet 2, Bank 1 to Bank 3, etc. need to participate in a contract corresponding to a “remittance” service in advance. For example, the contract is referred to as a remittance contract here. Each member can deposit any amount of fund at each anchor point, namely, a blockchain balance deposited by the member at a corresponding anchor point. For example, a blockchain balance deposited by Wallet 1 at anchor point 1 is 1000 RMB, a blockchain balance deposited by Bank 1 at anchor point 2 is 2000 RMB, and a blockchain balance deposited by Bank 2 at anchor point 3 is 3000 RMB. Each member is constrained by the remittance contract after participating in the remittance contract, so that a blockchain balance deposited by each member at each anchor point is registered in a blockchain ledger of the blockchain by the corresponding anchor point. In the blockchain, multiple ledger nodes (usually more than four accounting nodes) maintain one unified distributed ledger, and the ledger records a blockchain balance of each member at each anchor point. The accounting nodes enable ledger content recorded in all nodes to be consistent and be full accounting information in the blockchain through inter-node broadcast and a consensus algorithm. Therefore, it can be considered that all the nodes in the blockchain use a unified ledger, namely, the blockchain ledger. Because information in the blockchain has tamper-resistance and traceability features, information registered in the blockchain ledger is sufficiently reliable and can be trusted by all members and anchor points, and therefore can be used as an operation basis in various fund flow scenarios such as transfer and payment.

In addition, when participating in the remittance contract, each member records a status of trustiness imposed by the member in each anchor point in the remittance contract for subsequent routing determining. For example, as shown in FIG. 2, Wallet 2 does not deposit a blockchain balance at anchor point 3, but Wallet 2 sets anchor point 3 as a trusted anchor point. Therefore, a method that “a blockchain balance is 0” is used in FIG. 2 to express the trustiness, indicating that Wallet 2 is willing to receive blockchain balance remittance from another member at anchor point 3. In this case, anchor point 1 and anchor point 2 may be anchor points untrusted by Wallet 2, indicating that Wallet 2 is unwilling to receive blockchain balance remittance from another member at anchor point 1 or anchor point 2.

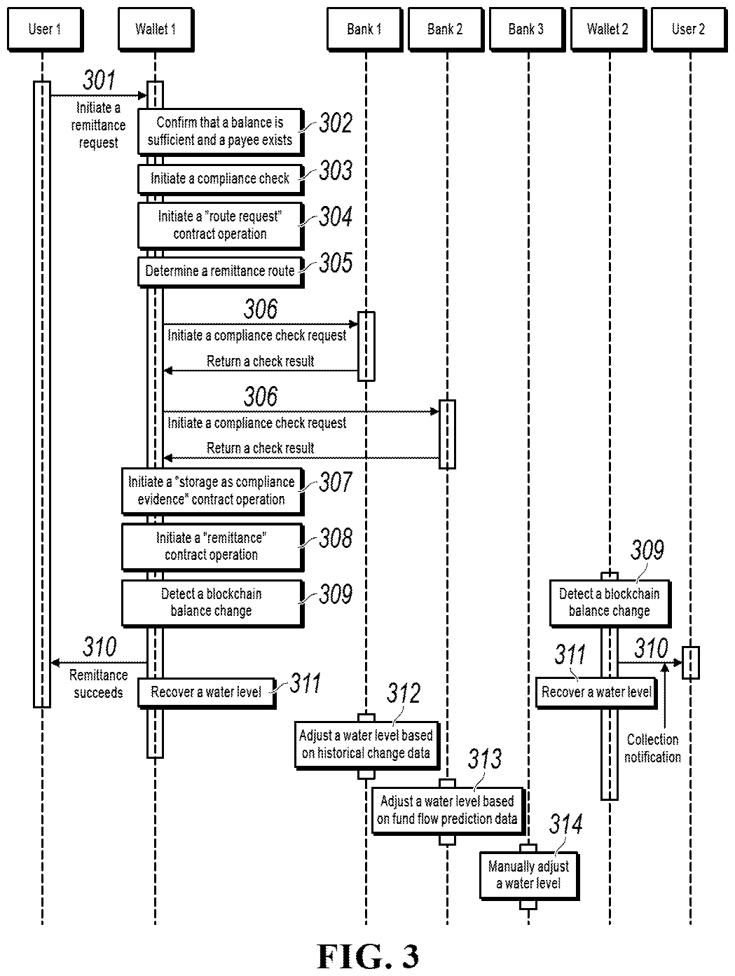

Based on the remittance scenario shown in FIG. 2, FIG. 3 is a schematic diagram illustrating interaction in a cross-border remittance process, according to an example implementation. As shown in FIG. 3, a process of interaction between user 1, user 2, Wallet 1, Wallet 2, Bank 1 to Bank 3, a blockchain, etc. can include the following steps.

Step 301: Wallet 1 receives a remittance request initiated by user 1.

In an implementation, user 1 can specify an amount of fund that need to be remitted and a payee in the remittance request. For example, assume that the fund amount specified by user 1 is 100 RMB, and the payee is user 2. In addition to initiating the remittance request by user 1, a remittance procedure can also be triggered by using another method in another scenario. For example, user 1 initiates a payment request with a fund amount being 100 RMB and a payee being user 2; and for another example, user 2 initiates a collection request with a fund amount being 100 RMB and a payer being user 1, which is not limited in the present specification.

Step 302: Wallet 1 confirms that a balance in customer fund account 1 corresponding to user 1 is sufficient, and confirms to Wallet 2 that user 2 serving as a payee exists.

In an implementation, as shown in FIG. 2, when the balance in customer fund account 1 corresponding to user 1 is 500 RMB, which is greater than 100 RMB that needs to be transferred, it is confirmed that the balance is sufficient; or when the balance is less than 100 RMB that needs to be transferred, it indicates that the balance is insufficient, and Wallet 1 can directly terminate remittance and return a remittance failure notification message to user 1.

In an implementation, Wallet 1 can send payee information to Wallet 2, and Wallet 2 determines whether the payee information is valid. The payee information can include a payee name, a payee account number, an account holding bank, etc., which is not limited in the present specification. Wallet 2 can return a corresponding verification result to Wallet 1 after verifying validity of the payee information. When it is confirmed that no payee exists, Wallet 1 can directly terminate remittance and return a remittance failure notification message to user 1.

Step 303: Wallet 1 can perform compliance check on a remittance event initiated by user 1 to user 2.

In an implementation, Wallet 1 can provide user 1 with a document submission entry, and user 1 provides a document to be checked of the remittance event. User 1 can submit static documents (such as an identity card photo of user 1) in advance that can be used for all remittance events, and submit dynamic documents (such as a recent remittance record) for a corresponding remittance event during remittance each time, to improve remittance efficiency.

In an implementation, the compliance check performed by Wallet 1 for the remittance event can include at least one of Know Your Customer (KYC)) check, Anti-Money Laundering (AML) check, etc., which is not limited in the present specification.

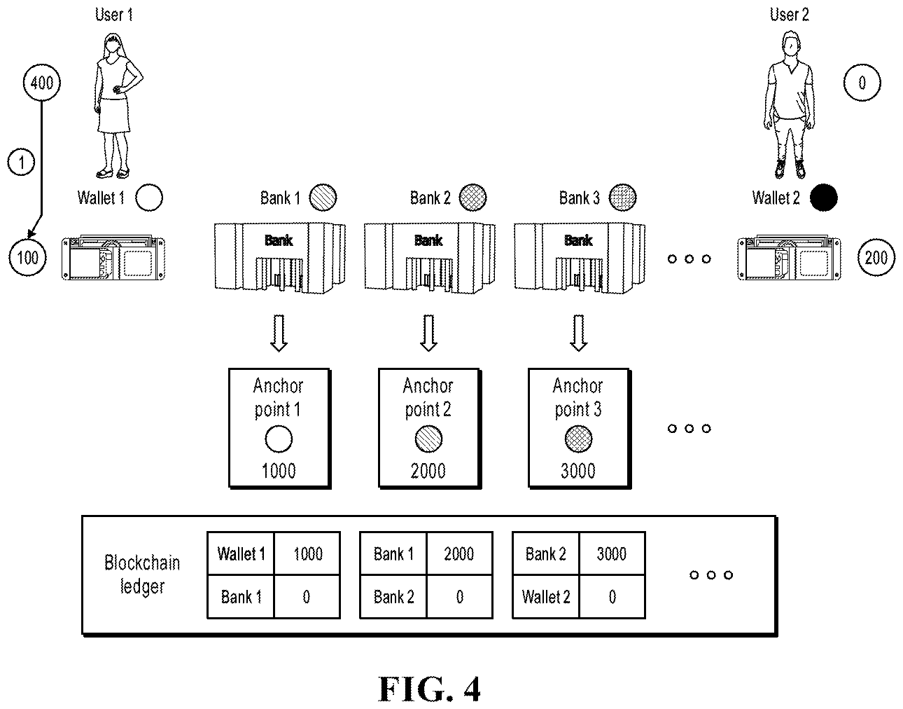

In an implementation, if a compliance check result obtained by Wallet 1 is unqualified, Wallet 1 can directly terminate remittance and return a remittance failure notification message to user 1; or Wallet 1 can provide user 1 with at least one document supplementation opportunity. For example, Wallet 1 can provide user 1 with a maximum of two opportunities. If user 1 supplements documents more than twice and the compliance check result is still unqualified, Wallet 1 can terminate remittance and return a remittance failure notification message to user 1. However, as shown in FIG. 4, if the compliance check result obtained by Wallet 1 is qualified, Wallet 1 can deduct 100 RMB from customer fund account 1 corresponding to user 1, and transfer 100 RMB to self-owned account 1 of Wallet 1.

Step 304: Wallet 1 initiates a “routing request” contract operation.

Step 305: Wallet 1 determines a remittance route.

In an implementation, after participating in a remittance contract, a member in the blockchain can invoke several contract operations supported in the remittance contract, for example, the “routing request” contract operation here. The contract operation is used to determine the remittance route for remittance from user 1 to user 2, thereby implementing a remittance operation.

In an implementation, the remittance route includes Wallet 1 serving as the most upstream member, Wallet 2 serving as the most downstream member, and several relay members between the two. Based on the technical solution in the present specification, an effect “remittance fund (for example, 100 RMB expected to be remitted by user 1) is transferred from Wallet 1 to Wallet 2” needs to be presented by using a blockchain balance deposited by each member at an anchor point on the blockchain in the remittance route and through blockchain balance flow, so that Wallet 2 provides user 2 with the remittance fund eventually.

Remittance fund flow between members in the remittance route can be divided into several times of fund flow performed between adjacent members, for example, between Wallet 1 and a relay member, between relay members, and between a relay member and Wallet 2. For example, when the remittance route is “Wallet 1-relay member 1-relay member 2-Wallet 2”, three pairs of adjacent members are included: “Wallet 1-relay member 1”, “relay member 1-relay member 2”, and “relay member 2-Wallet 2”, and three times of fund flow are involved in total: fund flow from Wallet 1 to relay member 1, fund flow from relay member 1 to relay member 2, and fund flow from relay member 2 to Wallet 2. Fund flow between each pair of adjacent members needs to be implemented by using an anchor point in the blockchain, and two conditions are involved: condition (1) A blockchain balance deposited by an upstream member in the adjacent members at a certain anchor point is greater than a remittance amount; and condition (2) A downstream member in the adjacent members sets the anchor point as a trusted anchor point. In other words, an associated anchor point exists between the upstream member and the downstream member. The upstream member has a sufficient blockchain balance at the associated anchor point for fund flow, and the downstream member is willing to receive transferred blockchain funds at the associated anchor point.

Wallet 1 can read the blockchain ledger by using full accounting information stored by Wallet 1, to understand blockchain balances of members such as Bank 1 to Bank 3 deposited at anchor points such as anchor point 1 to anchor point 3, and determine a status of each member of satisfying the condition (1) and condition (2) with reference to a trusted anchor point that is recorded in a contract and that corresponds to each member, thereby determining the remittance route.

Wallet 1 and Bank 1 are used as examples. A blockchain balance deposited by Wallet 1 at anchor point 1 is 1000 RMB, which is greater than a remittance amount of 100 RMB, and Bank 1 sets anchor point 1 as a trusted anchor point. Therefore, anchor point 1 is an associated anchor point between Wallet 1 and Bank 1, and fund flow between Wallet 1 and Bank 1 can be implemented based on anchor point 1.

Bank 1 and Bank 3 are used as examples. Bank 1 does not deposit a blockchain balance at anchor point 1 (because anchor point 1 is a trusted anchor point of Bank 1, it can be understood that the blockchain balance is 0), and deposits a blockchain balance of 2000 RMB at anchor point 2. The blockchain balance deposited by Bank 1 at anchor point 2 is greater than a remittance amount of 100 RMB, but anchor point 2 is an untrusted anchor point set by Bank 3. Consequently, no associated anchor point exists between Bank 1 and Bank 3, and fund flow cannot be implemented. In addition, Bank 1 and Bank 2 are used as examples. A blockchain balance deposited by Bank 1 at anchor point 2 is 2000 RMB, which is greater than a remittance amount of 100 RMB, and Bank 2 sets anchor point 2 as a trusted anchor point. Therefore, anchor point 2 is an associated anchor point between Bank 1 and Bank 2, and fund flow between Bank 1 and Bank 2 can be implemented based on anchor point 2.

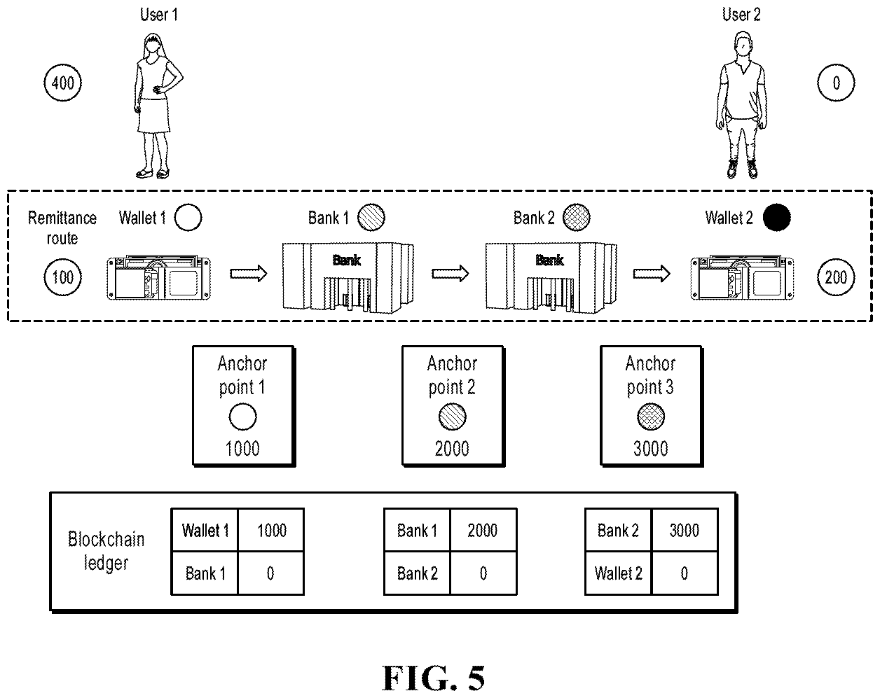

Similarly, whether the condition (1) and the condition (2) are satisfied between members in the blockchain can be determined by using the method above. Therefore, it can be determined that several relay members including Wallet 1 and Wallet 2 can be connected in series, thereby obtaining a complete remittance route. For example, FIG. 5 is a schematic diagram illustrating determining of a remittance route, according to an example implementation. As shown in FIG. 5, the remittance route can include Wallet 1-Bank 1-Bank 2-Wallet 2, an associated anchor point between Wallet 1 and Bank 1 is anchor point 1, an associated anchor point between Bank 1 and Bank 2 is anchor point 2, and an associated anchor point between Bank 2 and Wallet 2 is anchor point 3.

In an implementation, Wallet 1 can simultaneously determine multiple remittance routes, and select a remittance route to be finally used. For example, the condition can include a shortest path and lowest costs, which is not limited in the present specification.

Step 306: Wallet 1 initiates a compliance check request to all relay members in the remittance route.

In an implementation, when Wallet 1 and Wallet 2 belong to the same third-party payment platform, because Wallet 1 has completed the compliance check in step 303, the compliance check result is also applicable to Wallet 2. In other words, Wallet 2 does not need to repeat the compliance check. In another implementation, when Wallet 1 and Wallet 2 possibly belong to different third-party payment platforms, Wallet 1 can simultaneously initiate the compliance check request to all the relay members and Wallet 2 in step 306, so that all the relay members and Wallet 2 implement the compliance check. For ease of description, an example that Wallet 2 does not need to independently implement the compliance check is used below.

In an implementation, because compliance check methods used by members are different, a compliance check needs to be independently performed on the documents to be checked of user 1. In addition, Wallet 1 synchronously initiates the compliance check request to Bank 1 and Bank 2, so that Bank 1 and Bank 2 can concurrently initiate remittance event compliance checks, instead of serially performing the compliance checks between relay members, thereby shortening time consumed for the remittance event compliance checks, and improving compliance check efficiency.

In an implementation, Wallet 1 can push, to Bank 1 and Bank 2, the documents to be checked provided by user 1, to implement the compliance check based on the documents to be checked, for example, the KYC check or the AML check. To ensure integrity and reliability of the documents to be checked in a push process, before pushing, Wallet 1 can generate a digital digest corresponding to the documents to be checked, and record the digital digest in the blockchain by invoking a “document storage as evidence” contract operation. In addition, after receiving the pushed documents to be checked, Bank 1 and Bank 2 can read the digital digest from the blockchain and check the digital digest with a digital digest of the received documents to be checked. If the digital digests are the same, it is confirmed that the documents to be checked is complete and reliable. Otherwise, it indicates that the documents to be checked has a problem, and Wallet 1 needs to provide the documents to be checked again.

In an implementation, any member in the remittance route can return a corresponding check result to Wallet 1 after completing the compliance check request, and the check result can include a digital digest corresponding to detailed data for implementing the compliance check by the member, a determining result (qualified or unqualified), and signature information of the member (it indicates that the check result comes from the member). The detailed data corresponding to the digital digest included in the check result is related to privacy information of user 1, user 2, etc., a nondisclosure rule for implementing compliance check by the member, etc. Therefore, the digital digest is only included in the check result, and the specific detailed data is only recorded in the member, to be subsequently supplied to regulatory authorities for verification or checks.

It is worthwhile to note that, compared with the compliance check implemented by Wallet 1 in step 303, the compliance check implemented by each relay member in step 306 is more important and necessary. In some scenarios, the compliance check implemented by Wallet 1 in step 303 can even be omitted, but the compliance check implemented by each relay member in step 306 is often indispensable.

Step 307: Wallet 1 initiates a “storage as compliance evidence” contract operation to record an obtained check result in a blockchain ledger.

In an implementation, Wallet 1 can record check results returned by Bank 1, Bank 2, etc. to respective corresponding blocks by initiating the “storage as compliance evidence” contract operation, and further broadcast the check results to other nodes in the blockchain for recording. In other words, Wallet 1 records the check results in the blockchain ledger. The blockchain has tamper-resistance and traceability features, etc., so that the check result is sufficiently reliable and can be supplied to the regulatory authorities for subsequent retrieval, checks, etc.

Similarly, for the check result obtained in step 303, Wallet 1 can also record the check result in the blockchain ledger by initiating the “storage as compliance evidence” contract operation, for subsequent retrieval and checks.

In an implementation, when a check result returned by any member is unqualified, Wallet 1 can provide user 1 with at least one document supplementation opportunity. After obtaining supplementary documents, Wallet 1 can provide the member with the supplementary documents, so that the member can perform the compliance check again. Wallet 1 can record a digital digest of the supplementary documents in the blockchain ledger, so that the member compares the digital digest of the received supplementary documents with the digital digest recorded in the blockchain ledger, thereby determining whether the received supplementary documents is reliable. Assume that Wallet 1 can provide user 1 with a maximum of two opportunities. If user 1 supplements documents more than twice and the check result returned by the member is still unqualified, Wallet 1 can terminate remittance and return a remittance failure notification message to user 1.

In an implementation, after Wallet 1 initiates a compliance check request to Bank 1 and Bank 2, if a returned check result is not received within predetermined duration (for example, two minutes), the check result is determined as unqualified. Therefore, on one hand, the “unqualified” check result is recorded in the blockchain ledger by invoking the “storage as compliance evidence” contract operation. On the other hand, remittance is terminated and a remittance failure notification message is returned to user 1.

Step 308: When both compliance check results of Bank 1 and Bank 2 are qualified, Wallet 1 initiates a “remittance” contract operation to implement fund flow between members of the remittance route.

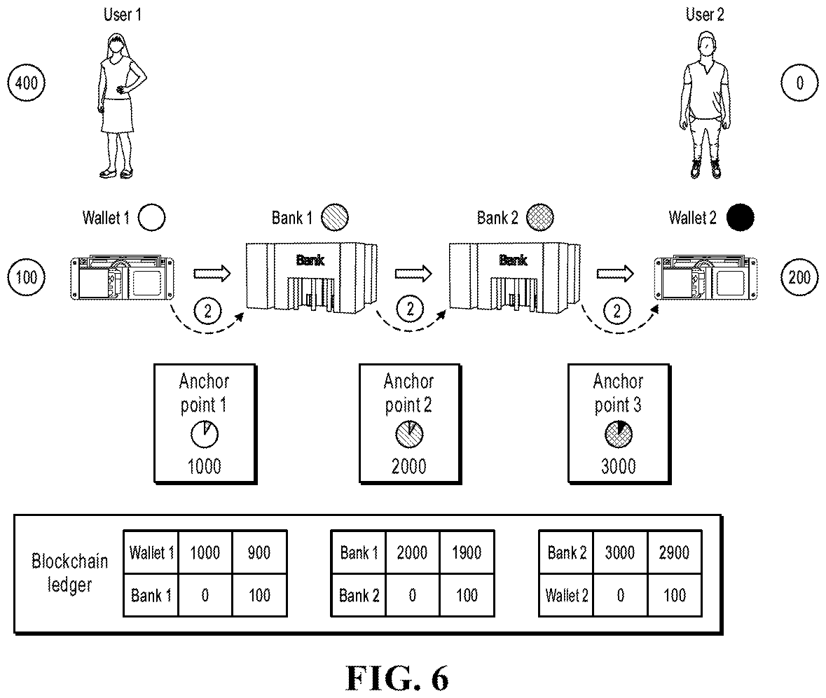

In an implementation, before the “remittance” contract operation takes effect, the blockchain balance shown in FIG. 5 is recorded in the blockchain ledger, including a blockchain balance of 1000 RMB deposited by Wallet 1 at anchor point 1, a blockchain balance of 2000 RMB deposited by Bank 1 at anchor point 2, a blockchain balance of 3000 RMB deposited by Bank 2 at anchor point 3, etc. However, as shown in FIG. 6, after the “remittance” contract operation takes effect, fund flow is successively performed between Wallet 1, Bank 1, Bank 2, and Wallet 2 in the remittance route.

Fund flow is implemented between Wallet 1 and Bank 1 by using anchor point 1, where 100 RMB is transferred from the blockchain balance deposited by Wallet 1 at anchor point 1 to a blockchain balance deposited by Bank 1 at anchor point 1, so that the blockchain balance deposited by Wallet 1 at anchor point 1 is reduced from 1000 RMB to 900 RMB, and the blockchain balance deposited by Bank 1 at anchor point 1 is increased from 0 RMB to 100 RMB.

Fund flow is implemented between Bank 1 and Bank 2 by using anchor point 2, where 100 RMB is transferred from the blockchain balance deposited by Bank 1 at anchor point 2 to a blockchain balance deposited by Bank 2 at anchor point 2, so that the blockchain balance deposited by Bank 1 at anchor point 2 is reduced from 2000 RMB to 1900 RMB, and the blockchain balance deposited by Bank 2 at anchor point 2 is increased from 0 RMB to 100 RMB.

Fund flow is implemented between Bank 2 and Wallet 2 by using anchor point 3, where 100 RMB is transferred from the blockchain balance deposited by Bank 2 at anchor point 3 to a blockchain balance deposited by Wallet 2 at anchor point 3, so that the blockchain balance deposited by Bank 2 at anchor point 3 is reduced from 3000 RMB to 2900 RMB, and the blockchain balance deposited by Wallet 2 at anchor point 3 is increased from 0 RMB to 100 RMB.

In the fund flow processes between Wallet 1 and Bank 1, Bank 1 and Bank 2, Bank 2 and Wallet 2, self-owned account 1 of Wallet 1 has an increase of 100 RMB transferred from customer fund account 1 of user 1 and the blockchain balance deposited by Wallet 1 at anchor point 1 is reduced by 100 RMB, and it is equivalent to that a fund flow net amount of Wallet 1 is 0 RMB. The blockchain balance deposited by Bank 1 at anchor point 1 is increased by 100 RMB and the blockchain balance deposited by Bank 1 at anchor point 2 is reduced by 100 RMB, and it is equivalent to that a fund flow net amount of Bank 1 is 0 RMB. The blockchain balance deposited by Bank 2 at anchor point 2 is increased by 100 RMB and the blockchain balance deposited by Bank 2 at anchor point 3 is reduced by 100 RMB, and it is equivalent to that a fund flow net amount of Bank 2 is 0 RMB. The blockchain balance deposited by Wallet 2 at anchor point 3 is increased by 100 RMB, and it is equivalent to that 100 RMB remitted by user 1 is transferred to the blockchain balance of Wallet 2 by using the remittance route.

It is worthwhile to note that, because all nodes in the blockchain use a unified blockchain ledger, that is, because the blockchain balances deposited by all members at all anchor points are recorded in the blockchain ledger, the blockchain can simultaneously perform unified adjustment on the blockchain balance deposited by Wallet 1 at anchor point 1, blockchain balances deposited by Bank 1 at anchor point 1 and anchor point 2, blockchain balances deposited by Bank 2 at anchor point 2 and anchor point 3, and the blockchain balance deposited by Wallet 2 at anchor point 3, so that the blockchain balance of Wallet 1 is reduced by 100 RMB, the blockchain balance of Wallet 2 is increased by 100 RMB, and it is equivalent to that blockchain balances of all relay members do not change.

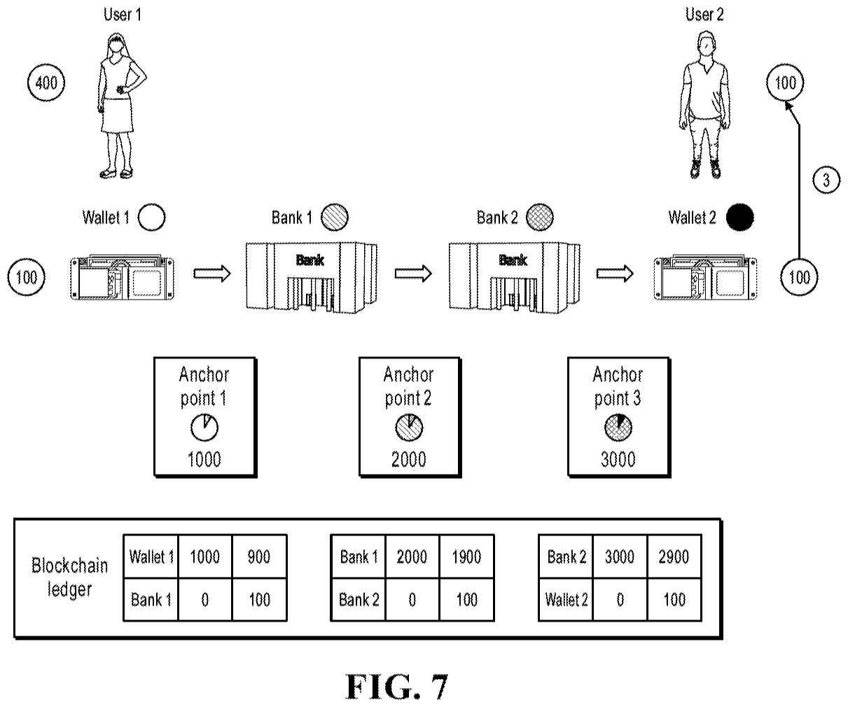

Therefore, as shown in FIG. 7, Wallet 2 can transfer 100 RMB from self-owned account 2 to customer fund account 2 opened by user 2 in Wallet 2. In combination with 100 RMB increased in the blockchain balance deposited by Wallet 2 at anchor point 3, it is equivalent to that a final fund flow net amount of Wallet 2 is 0 RMB, and user 2 obtains 100 RMB from user 1.

Step 309: Wallet 1 and Wallet 2 separately detect a blockchain balance change.

Step 310: Wallet 1 sends a remittance success notification to user 1, and Wallet 2 sends a collection notification to user 2.

It is worthwhile to note that, in the implementation above, Wallet 1 has self-owned account 1 and Wallet 2 has self-owned account 2. Wallet 1 transfers fund between self-owned account 1 and customer fund account 1 of user 1 to obtain remittance fund provided by user 1, Wallet 2 transfers fund between self-owned account 2 and customer fund account 2 of user 2 to provide user 2 with the remittance fund, and the blockchain balances of Wallet 1 and Wallet 2 separately change, provided that a fund flow net amount between a self-owned account and a blockchain balance is 0 RMB. In another implementation, another processing method exists, for example:

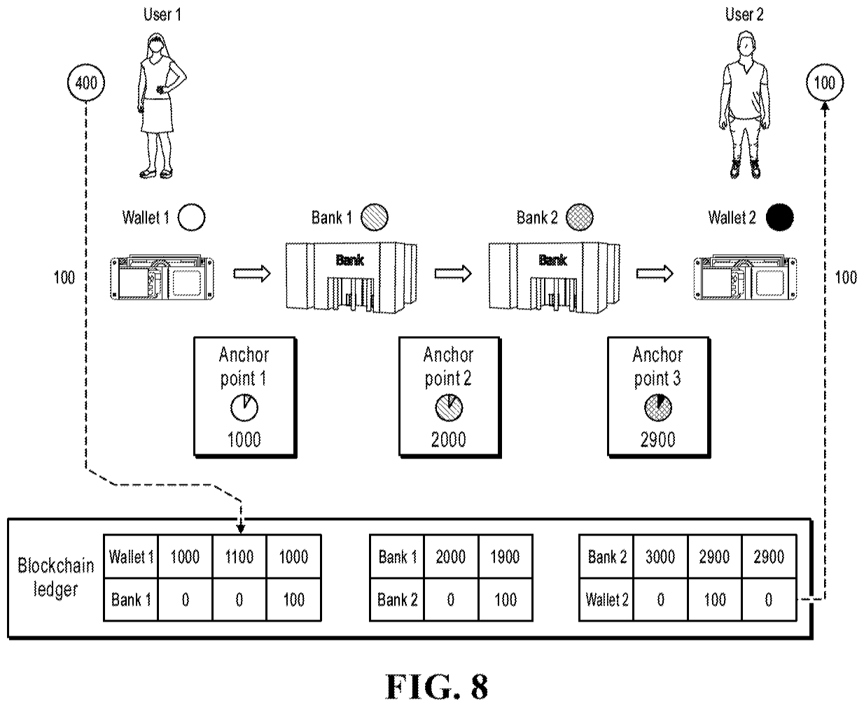

FIG. 8 is a schematic diagram illustrating remittance that remittance funds are transferred to a blockchain balance, according to an example implementation. As shown in FIG. 8, it can be seen from change information of a blockchain balance recorded in a blockchain ledger that an initial blockchain balance deposited by Wallet 1 at anchor point 1 is 1000 RMB. After user 1 initiates a remittance request for user 2, Wallet 1 withdraws 100 RMB from customer fund account 1 corresponding to user 1, and deposits the withdrawn 100 RMB in the blockchain balance deposited by Wallet 1 at anchor point 1, so that the blockchain balance of Wallet 1 at anchor point 1 is increased to 1100 RMB. Then, Wallet 1 invokes a “remittance” contract operation, so that the blockchain balance deposited by Wallet 1 at anchor point 1 is reduced from 1100 RMB to 1000 RMB, and a blockchain balance deposited by Bank 1 at anchor point 1 is increased from 0 RMB to 100 RMB. In addition, 100 RMB is successively transferred between Bank 1, Bank 2, and Wallet 2 based on an implementation similar to the implementation shown in FIG. 7, so that a blockchain balance deposited by Wallet 2 at anchor point 3 is increased from 0 RMB to 100 RMB. Finally, Wallet 2 withdraws 100 RMB deposited at anchor point 3 and transfers 100 RMB to customer fund account 2 of user 2, to complete remittance from user 1 to user 2. Based on the process above, Wallet 1 and Wallet 2 directly deposit funds provided by user 1 in blockchain balances and participate in fund flow in a blockchain without opening self-owned account 1 and self-owned account 2.

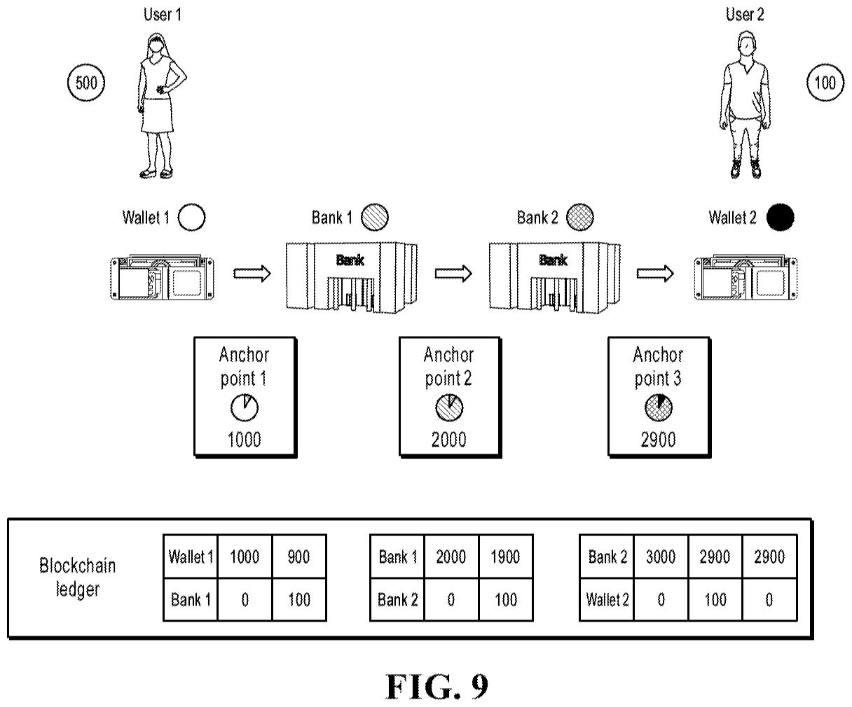

FIG. 9 is a schematic diagram illustrating credit-based remittance, according to an example implementation. As shown in FIG. 9, it can be seen from change information of a blockchain balance recorded in a blockchain ledger that an initial blockchain balance deposited by Wallet 1 at anchor point 1 is 1000 RMB. After user 1 initiates a remittance request for user 2, Wallet 1 can perform advance fund payment for a remittance operation of user 1 based on credit granted by Wallet 1 to user 1, and wait for user 1 to perform subsequent repayment. Therefore, based on fund flow between Wallet 1, Bank 1, Bank 2, and Wallet 2, the blockchain balance deposited by Wallet 1 at anchor point 1 is reduced from 1000 RMB to 900 RMB, a fund flow net amount is reduced by 100 RMB, and all fund flow net amounts of Bank 1, Bank 2, and Wallet 2 are 0 RMB. For a specific fund flow process, refer to the implementation above. Details are omitted here for simplicity.

Step 311: After daily settlement, Wallet 1 and Wallet 2 perform water level recovery on blockchain balances deposited at anchor points.

In an implementation, each member of the blockchain performs capital settlement based on a predetermined period. For example, the predetermined period can be one day, three days, or one week, which is not limited in the present specification. For example, if the predetermined period is one day, each member performs capital settlement, namely, daily settlement, at a specific moment (for example, 18:00) each day. A blockchain balance constantly varies with a transaction, which is similar to a water level change in a bucket, and therefore blockchain balance adjustment can be vividly referred to as “water level” adjustment.

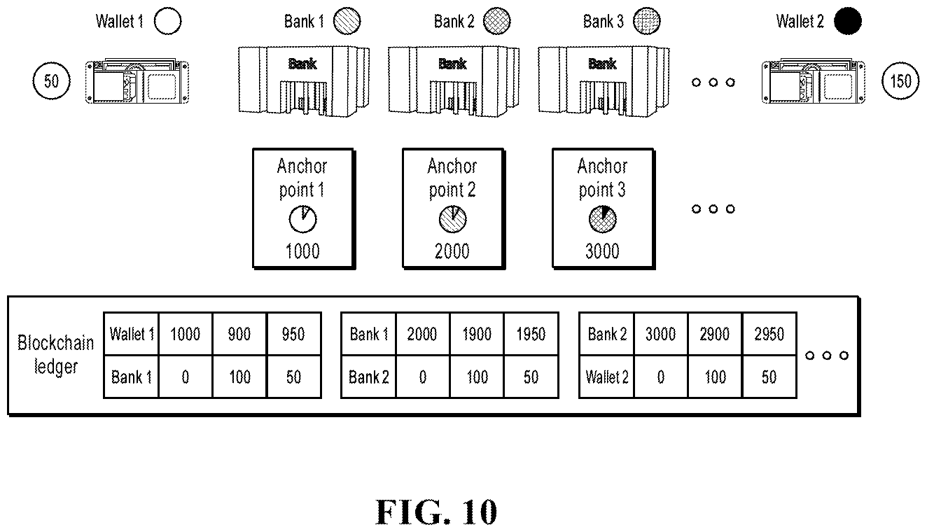

For example, FIG. 10 is a schematic diagram illustrating transaction information generated during capital settlement, according to an example implementation. As shown in FIG. 10, assume that Wallet 1, Wallet 2, and Bank 1 to Bank 3 are involved in two transactions in total on a current day, the first transaction is that user 1 transfers 100 RMB to user 2, and the second transaction is that user 2 transfers 50 RMB to user 1. Therefore, it can be determined during settlement that a remaining blockchain balance deposited by Wallet 1 at anchor point 1 is 950 RMB, a blockchain balance deposited by Bank 1 at anchor point 1 is 50 RMB, a blockchain balance deposited by Bank 1 at anchor point 2 is 1950 RMB, a blockchain balance deposited by Bank 2 at anchor point 2 is 50 RMB, a blockchain balance deposited by Bank 2 at anchor point 3 is 2950 RMB, a blockchain balance deposited by Wallet 2 at anchor point 3 is 50 RMB, etc.

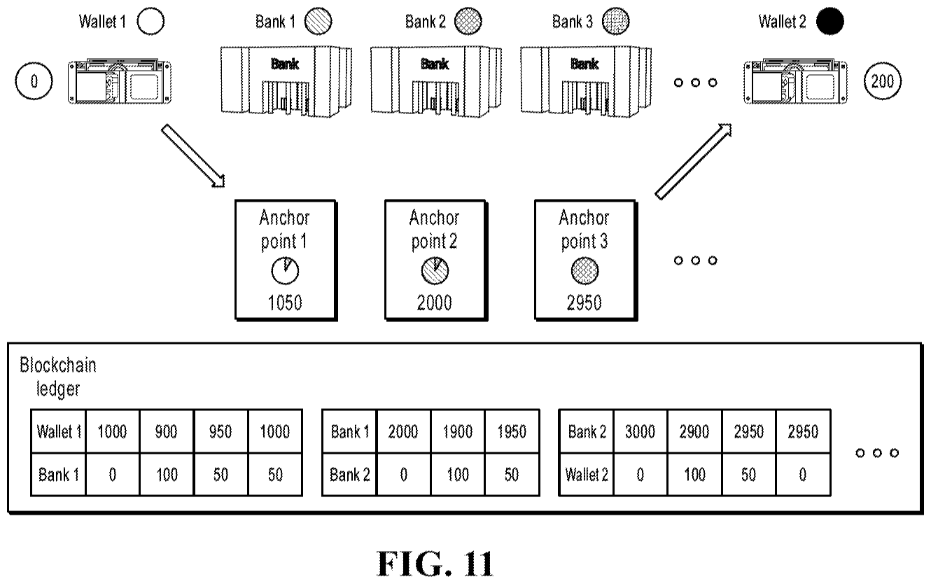

Based on information about fund flow between members recorded in the blockchain ledger, it can be determined that the blockchain balance deposited by Wallet 1 at anchor point 1 changes from 1000 RMB to 900 RMB and from 900 RMB to 950 RMB. Therefore, a final net fund change amount is: 950-1000=−50 RMB, that is, 50 RMB is reduced. Therefore, as shown in FIG. 11, Wallet 1 can deposit 50 RMB from self-owned account 1 to the blockchain balance deposited at anchor point 1 (a balance of self-owned account 1 is accordingly reduced from 50 RMB to 0 RMB), so that the blockchain balance is recovered from 950 RMB to 1000 RMB, and change information of the blockchain balance is registered in the blockchain ledger by anchor point 1. By initiating a fund deposit contract operation, Wallet 1 can deposit 50 RMB from self-owned account 1 to the blockchain balance deposited at anchor point 1.

Similarly, based on information about fund flow between members recorded in the blockchain ledger, it can be determined that the blockchain balance deposited by Wallet 2 at anchor point 3 changes from 0 RMB to 100 RMB and from 100 RMB to 50 RMB. Therefore, a final net fund change amount is: 50-0=50 RMB, namely, 50 RMB is increased. Therefore, as shown in FIG. 11, Wallet 2 can withdraw 50 RMB from the blockchain balance deposited at anchor point 1 and deposit 50 RMB to self-owned account 2 (a balance of self-owned account 2 is accordingly increased from 150 RMB to 200 RMB), so that the blockchain balance is recovered from 50 RMB to 0 RMB, and change information of the blockchain balance is registered in the blockchain ledger by anchor point 3. By initiating a fund withdrawal contract operation, Wallet 2 can withdraw 50 RMB from the blockchain balance deposited at anchor point 1 and deposit 50 RMB to self-owned account 2.

Step 312: Perform water level adjustment on a blockchain balance of Bank 1 based on historical change data.

In an implementation, Bank 1 can read, from the blockchain ledger, all transactions that Bank 1 participates in, to obtain historical change data of Bank 1. Therefore, Bank 1 can predict a change of a blockchain balance at each anchor point on the next day based on full historical change data or historical change data in a specific time period (for example, latest three days, latest week, or Monday in latest five weeks), to accordingly perform water level adjustment on the blockchain balance.

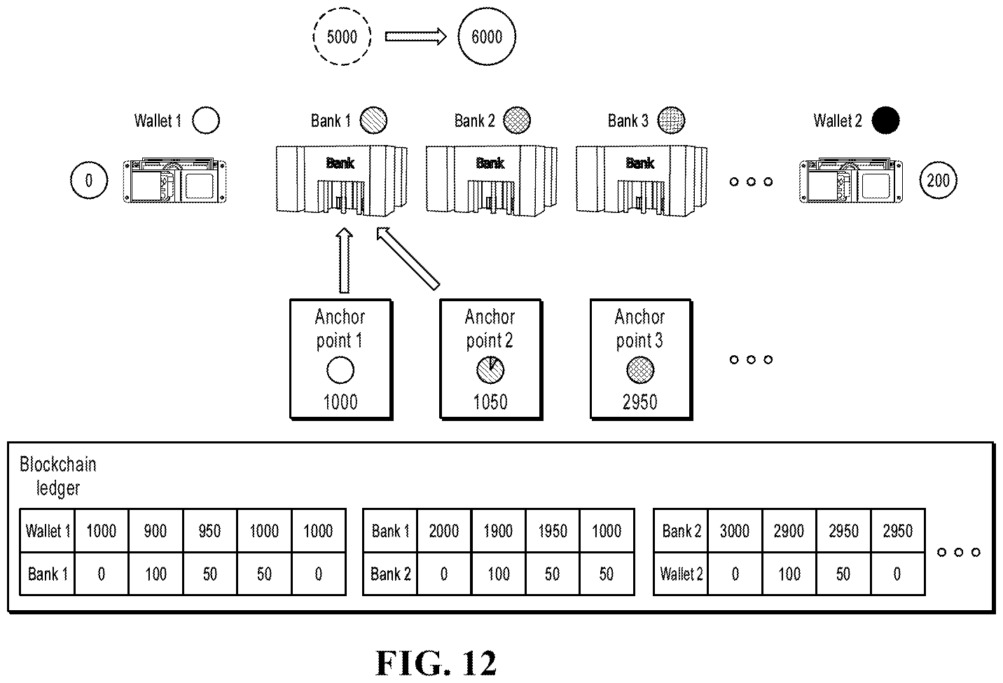

For example, the historical change data indicates that a net fund change amount does not exceed 100 RMB when an initial amount of the blockchain balance deposited by Bank 1 at anchor point 1 is 0 RMB, and a net fund change amount does not exceed 1000 RMB when an initial amount of the blockchain balance deposited by Bank 1 at anchor point 2 is 2000 RMB. In this case, as shown in FIG. 12: because a difference between the initial amount 0 RMB at anchor point 1 and a value 100 RMB is small, the blockchain balance deposited by Bank 1 at anchor point 1 can be maintained to be 0 RMB, and therefore 50 RMB needs to be withdrawn from the blockchain balance deposited at anchor point 1 and needs to be deposited to the self-owned account of Bank 1, so that the blockchain balance deposited by Bank 1 at anchor point 1 is recovered to 0 RMB. For example, Bank 1 can initiate a fund withdrawal contract operation, to withdraw 50 RMB from the blockchain balance deposited at anchor point 1, and deposit 50 RMB in the self-owned account of Bank 1. Because a difference between the initial amount 2000 RMB at anchor point 2 and a value 1000 RMB is large, the blockchain balance deposited by Bank 1 at anchor point 2 can be adjusted to 1000 RMB, and therefore 950 RMB needs to be withdrawn from the blockchain balance deposited at anchor point 2 and needs to be deposited to the self-owned account of Bank 1, so that the blockchain balance deposited by Bank 1 at anchor point 2 is reduced to 1000 RMB. For example, Bank 1 can initiate a fund withdrawal contract operation, to withdraw 950 RMB from the blockchain balance deposited at anchor point 2, and deposit 950 RMB in the self-owned account of Bank 1.

It can be seen from the implementations shown in FIG. 11 and FIG. 12 that adjustment can be performed between a blockchain balance and a self-owned account of a member in a water level adjustment process.

Step 313: Perform water level adjustment on a blockchain balance of Bank 2 based on fund flow prediction data.

In an implementation, Bank 2 can read information from the blockchain ledger such as all transactions that occur in an entire network, and generate corresponding fund flow prediction data based on the information. For example, the information can be next day's transactions in the entire network, or can at least include a blockchain balance change on the next day. In this way, water level adjustment is performed on the blockchain balance. Certainly, the fund flow prediction data can be generated by another member, anchor point, blockchain, or any object instead of Bank 2, which is not limited in the present specification.

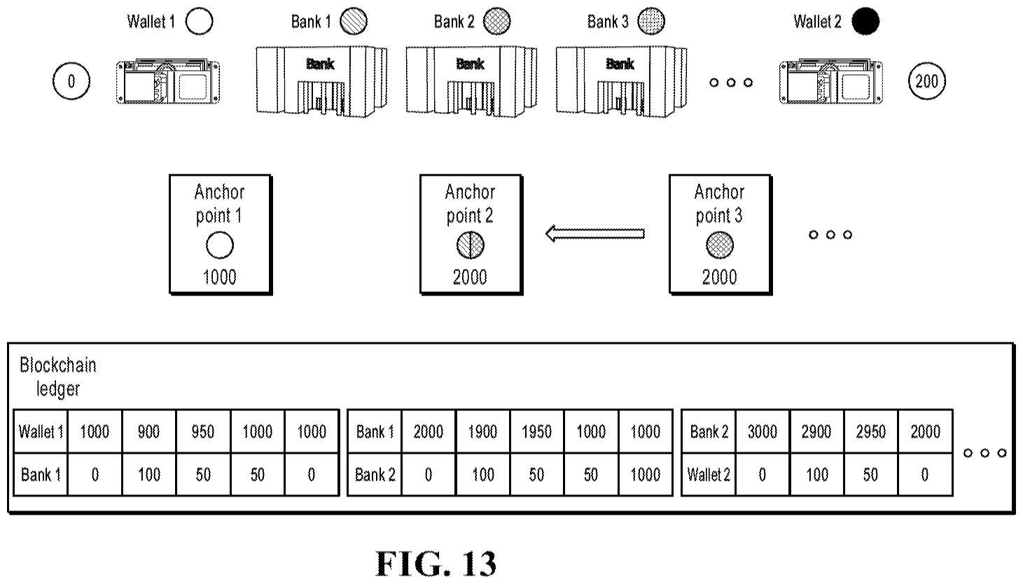

For example, as shown in FIG. 13, assume that Bank 2 predicts that a net fund change amount at anchor point 2 is close to 1000 RMB and a net fund change net amount at anchor point 3 is less than 2000 RMB on the next day. Bank 2 can transfer 950 RMB from the blockchain balance deposited by Bank 2 at anchor point 3 to the blockchain balance deposited by Bank 2 at anchor point 2. For example, Bank 2 can initiate a fund withdrawal contract operation, to withdraw 950 RMB from the blockchain balance deposited at anchor point 3, and then initiate a fund deposit contract operation to deposit 950 RMB in the blockchain balance deposited at anchor point 2, so that the blockchain balance deposited at anchor point 2 is increased to 1000 RMB, and the blockchain balance deposited at anchor point 3 is reduced to 2000 RMB, thereby satisfying a requirement for predicting fund changes at anchor point 2 and anchor point 3 on the next day.

It can be seen from the implementation shown in FIG. 13 that blockchain balances at multiple anchor points can be adjusted in a water level adjustment process.

Step 314: Manually adjust a blockchain balance of Bank 3.

In an implementation, each member can use any one or a combination of the water level recovery solution, the solution of performing water level adjustment based on historical change data, the solution of performing water level adjustment based on fund flow prediction data, a manual water level adjustment solution, etc. (for example, the water level recovery solution is used for blockchain balances at some anchor points, and the solution of performing water level adjustment based on historical change data is used for blockchain balances at some other anchor points), which is not limited in the present specification.

In an implementation, a member can perform water level adjustment on a blockchain balance of the member at each anchor point by invoking a “balance adjustment” contract operation. The “balance adjustment” contract operation can include the previously described fund deposit contract operation, the fund withdrawal contract operation, etc. In addition to adjustment between blockchain balances and between a blockchain balance and a self-owned account, if a member obtains credit at an anchor point, the “balance adjustment” contract operation can instruct the anchor point to adjust a blockchain balance deposited by the member based on credit (in other words, a value of the blockchain balance registered in the blockchain ledger changes).

It is worthwhile to note that there can be multiple types of blockchains in the present specification, which is not limited in the present specification. For example, when the blockchain is a consortium chain, all members in the remittance route are members in the consortium chain, to ensure that the members have corresponding operation rights.

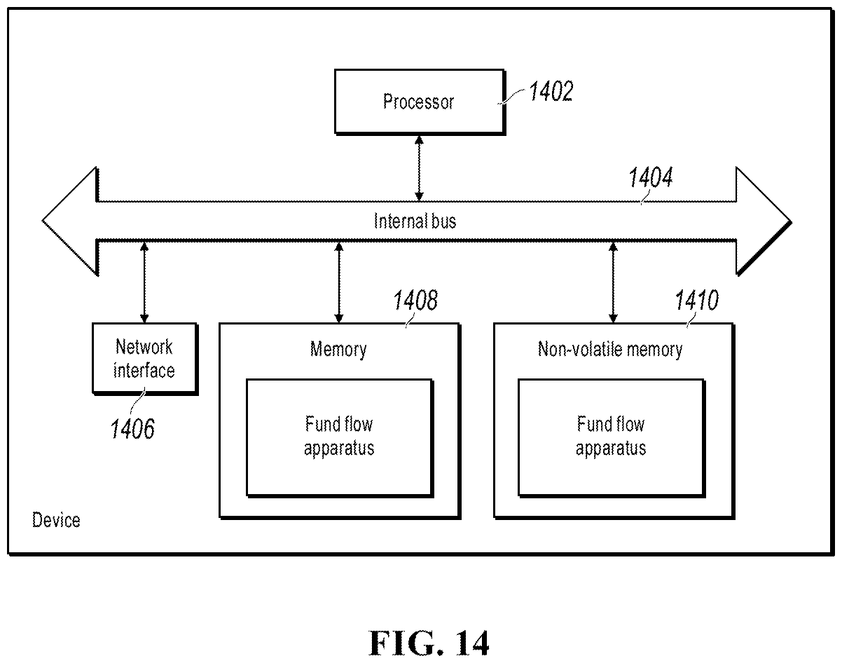

FIG. 14 is a schematic structural diagram illustrating a device, according to an example implementation. Referring to FIG. 14, in terms of hardware, the device includes a processor 1402, an internal bus 1404, a network interface 1406, a memory 1408, and a nonvolatile memory 1410, and certainly can further include hardware needed by other services. The processor 1402 reads a corresponding computer program from the nonvolatile memory 1410 and stores the computer program in the memory 1408 for running, and a fund flow apparatus is logically formed. Certainly, in addition to a software implementation, one or more implementations of the present specification do not exclude other implementations, for example, a logic device or a combination of hardware and software. In other words, an execution body of the following processing procedure is not limited to logical units, and can also be hardware or a logic device.

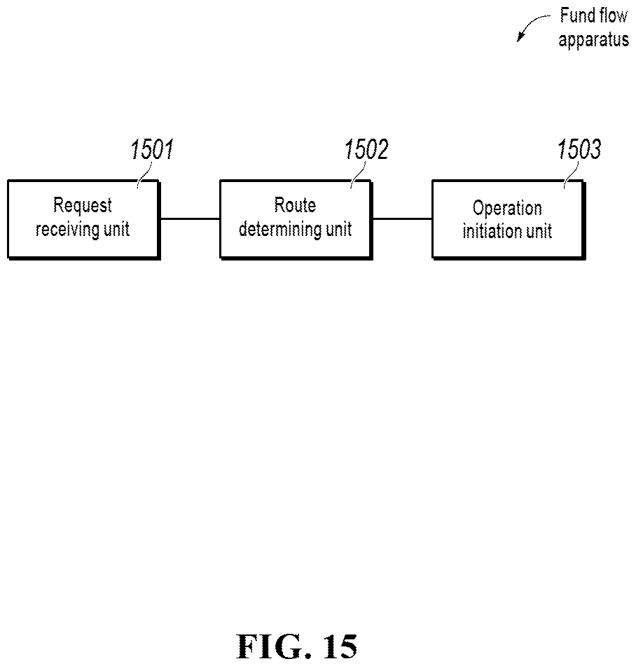

Referring to FIG. 15, in a software implementation, the fund flow apparatus can include the following: a request receiving unit 1501, configured to enable a first member of a blockchain to receive a request for fund flow of a specified amount between a payer and a payee; a route determining unit 1502, configured to enable the first member to determine a fund flow route between the first member and a second member corresponding to the payee in the blockchain, where the fund flow route includes the first member, the second member, and several relay members, and blockchain balances deposited by all members of the fund flow route at all anchor points of the blockchain are registered in a blockchain ledger of the blockchain; and an operation initiation unit 1503, configured to enable the first member to initiate a fund flow contract operation, where after the fund flow contract operation takes effect, the blockchain balances of all the members of the fund flow route registered in the blockchain ledger uniformly change, so that the second member pays funds of the specified amount to the payee.

Optionally, the request receiving unit 1501 is configured to enable the first member to receive a fund payment request initiated by the payer for the payee; or enable the first member to receive a fund receiving request initiated by the payee for the payer.

Optionally, an associated anchor point exists between adjacent members in the fund flow route, a blockchain balance deposited by an upstream member in the adjacent members at the associated anchor point is greater than the specified amount, and the associated anchor point is set as a trusted anchor point by a downstream member.

Optionally, the route determining unit 1502 is configured to enable the first member to initiate a route selection contract operation, where after the route selection contract operation takes effect, the fund flow route is determined based on a status of trustiness imposed by each member in each anchor point and a deposit status of a blockchain balance of each member at each anchor point registered in the blockchain ledger.

Optionally, after the fund flow contract operation takes effect, a blockchain balance deposited by the upstream member in the adjacent members at the associated anchor point is reduced by the specified amount, and a blockchain balance deposited by the downstream member at the associated anchor point is increased by the specified amount, so that the blockchain balances of all the members of the fund flow route registered in the blockchain ledger uniformly change.

Optionally, the operation initiation unit 1503 is configured to enable the first member to initiate the fund flow contract operation after obtaining the fund of the specified amount provided by the payer and depositing the fund of the specified amount in a blockchain balance of the first member or a self-owned account of the first member; or enable the first member to initiate the fund flow contract operation based on credit of the payer before obtaining the fund of the specified amount provided by the payer.

Optionally, the fund of the specified amount received by the payee comes from a blockchain balance of the second member or a self-owned account of the second member.

Optionally, fund flow performed between the first member and the second member based on the request for fund flow is cross-border fund flow.

Optionally, fund flow performed between the first member and the second member based on the request for fund flow is remittance, payment, or collection.

Optionally, all the members in the fund flow route belong to different institutions or different branches of the same institution.

Optionally, the blockchain is consortium chain, and each member in the fund flow route is member of the consortium chain.

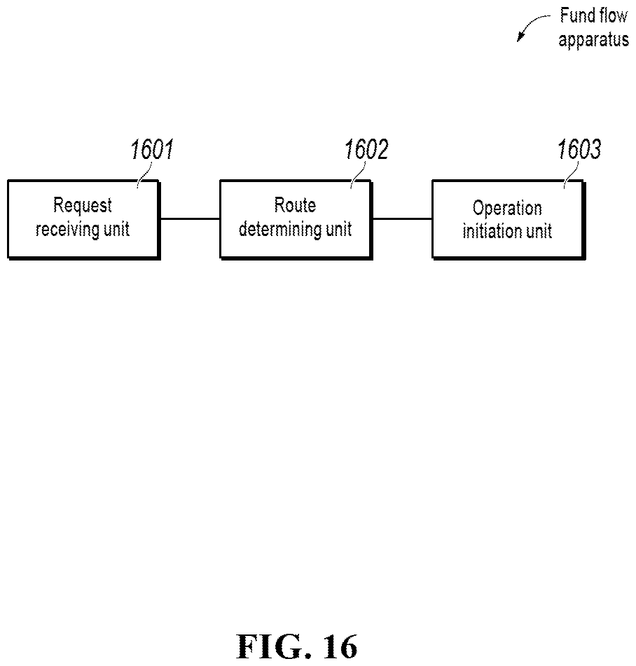

Referring to FIG. 16, in a software implementation, a fund flow apparatus can include the following: a request receiving unit 1601, configured to enable a first member of a blockchain to receive a request for fund flow of a specified amount between a payer and a payee; a route determining unit 1602, configured to enable the first member to determine a fund flow route between the first member and a second member corresponding to the payee in the blockchain, where the fund flow route includes the first member and the second member, and blockchain balances deposited by all members of the fund flow route at all anchor points of the blockchain are registered in a blockchain ledger of the blockchain; and an operation initiation unit 1603, configured to enable the first member to initiate a fund flow contract operation, where after the fund flow contract operation takes effect, the blockchain balances of all the members of the fund flow route registered in the blockchain ledger uniformly change, so that the second member pays fund of the specified amount to the payee.

Optionally, the request receiving unit 1601 is configured to enable the first member to receive a fund payment request initiated by the payer for the payee; or enable the first member to receive a fund receiving request initiated by the payee for the payer.

Optionally, an associated anchor point exists between the first member and the second member, a blockchain balance deposited by the first member at the associated anchor point is greater than the specified amount, and the associated anchor point is set as a trusted anchor point by the second member.

Optionally, the route determining unit 1602 is configured to enable the first member to initiate a route selection contract operation, where after the route selection contract operation takes effect, the fund flow route is determined based on a status of trustiness imposed by each member in each anchor point and a deposit status of a blockchain balance of each member at each anchor point registered in the blockchain ledger.

Optionally, after the fund flow contract operation takes effect, a blockchain balance deposited by an upstream member in adjacent members at the associated anchor point is reduced by the specified amount, and a blockchain balance deposited by a downstream member at the associated anchor point is increased by the specified amount, so that the blockchain balances of all the members of the fund flow route registered in the blockchain ledger uniformly change.

Optionally, the operation initiation unit 1603 is configured to enable the first member to initiate the fund flow contract operation after obtaining the fund of the specified amount provided by the payer and depositing the fund of the specified amount in a blockchain balance of the first member or a self-owned account of the first member; or enable the first member to initiate the fund flow contract operation based on credit of the payer before obtaining the fund of the specified amount provided by the payer.

Optionally, the fund of the specified amount received by the payee come from a blockchain balance of the second member or a self-owned account of the second member.

Optionally, fund flow performed between the first member and the second member based on the request for fund flow is cross-border fund flow.

Optionally, fund flow performed between the first member and the second member based on the request for fund flow is remittance, payment, or collection.

Optionally, all the members in the fund flow route belong to different institutions or different branches of the same institution.

Optionally, the blockchain is consortium chain, and each member in the fund flow route is member of the consortium chain.

The system, apparatus, module, or unit described in the implementations above can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or a combination of any of these devices.

In a typical configuration, the computer includes one or more processors (CPU), an input/output interface, a network interface, and a memory.

The memory can include a non-persistent memory, a random access memory (RAM) and/or a nonvolatile memory in a computer readable medium, for example, a read-only memory (ROM) or a flash memory (flash RAM). The memory is an example of the computer readable medium.

The computer readable medium includes persistent, non-persistent, movable, and unmovable media that can implement information storage by using any method or technology. Information can be a computer readable instruction, a data structure, a program module, or other data. A computer storage medium includes but is not limited to a phase-change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a magnetic tape, a magnetic disk storage, a quantum memory, a grapheme-based storage medium, another magnetic storage device, or any other non-transmission medium. The computer storage medium can be used to store information that can be accessed by a computing device Based on the definition in the present specification, the computer readable medium does not include transitory computer readable medium(transitory media), for example, a modulated data signal and carrier.

It is worthwhile to further note that the term “include”, “contain”, or their any other variant is intended to cover a non-exclusive inclusion, so that a process, a method, merchandise, or a device that includes a list of elements not only includes those elements but also includes other elements which are not expressly listed, or further includes elements inherent to such process, method, merchandise, or device. An element preceded by “includes a . . . ” does not, without more constraints, preclude the existence of additional identical elements in the process, method, merchandise, or device that includes the element.

Specific implementations of the present specification are described above. Other implementations fall within the scope of the appended claims. In some situations, the actions or steps described in the claims can be performed in an order different from the order in the implementations and the desired results can still be achieved. In addition, the process described in the accompanying drawings does not necessarily need a particular execution order to achieve the desired results. In some implementations, multitasking and parallel processing can be advantageous.

The terms used in the one or more implementations of the present specification are merely used for the purpose of describing specific implementations, and are not intended to limit the one or more of the implementations of the present specification. The terms “a”, “said”, and “the” of singular forms used in the present specification and the appended claims are also intended to include plural forms, unless otherwise specified in the context clearly. It should also be understood that, the term “and/or” used in the present specification indicates and includes any or all possible combinations of one or more associated listed items.

It should be understood that although terms of first, second, third, etc. can be used in one or more implementations of the present specification to describe various types of information, the information is not limited to the terms. These terms are only used to differentiate information of a same type. For example, without departing from the scope of one or more implementations of the present specification, the first information can also be referred to as second information. Similarly, the second information can also be referred to as the first information. Depending on the context, for example, the word “if” used here can be explained as “while”, “when”, or “in response to determining”.

The descriptions above are only example implementations of the one or more implementations of the present specification, but are not intended to limit one or more implementations of the present specification. Any modification, equivalent replacement, improvement, etc. made without departing from the spirit and principle of the one or more implementations of the present specification shall fall within the protection scope of the one or more implementations of the present specification.

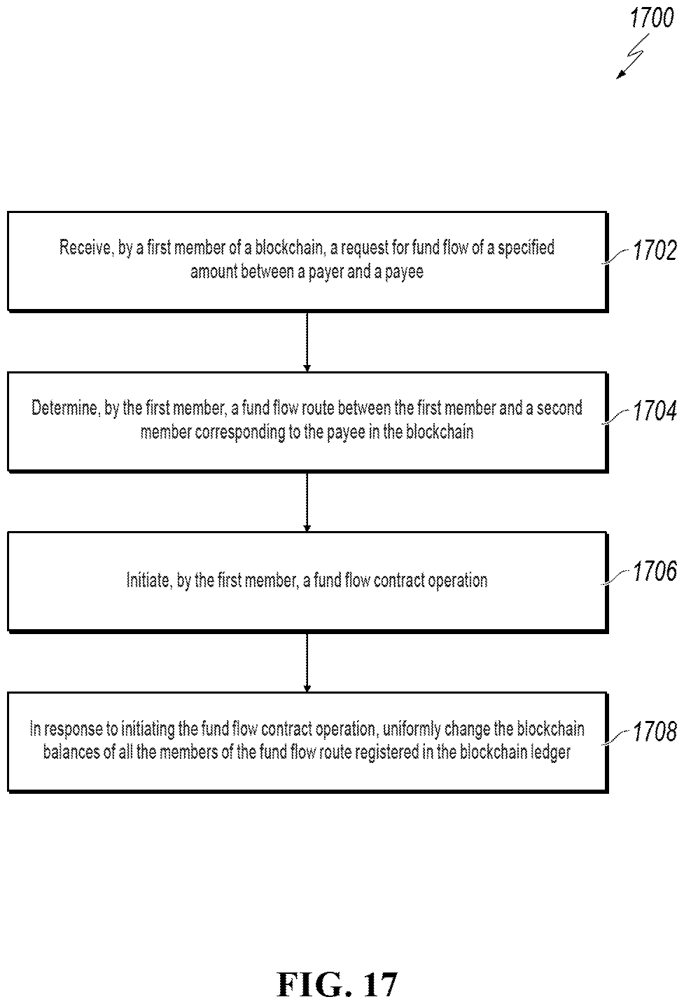

FIG. 17 is a flowchart illustrating an example of a computer-implemented method 1700 for a fund flow, according to an implementation of the present disclosure. For clarity of presentation, the description that follows generally describes method 1700 in the context of the other figures in this description. However, it will be understood that method 1700 can be performed, for example, by any system, environment, software, and hardware, or a combination of systems, environments, software, and hardware, as appropriate. In some implementations, various steps of method 1700 can be run in parallel, in combination, in loops, or in any order.

At 1702, a request for fund flow of a specified amount between a payer and a payee is received by a first member of a blockchain. In some implementations, receiving, by the first member of the blockchain, the request for fund flow of the specified amount between the payer and the payee, comprises: receiving, by the first member, a fund payment request initiated by the payer for the payee. In some implementations, receiving, by the first member of the blockchain, the request for fund flow of the specified amount between the payer and the payee, comprises: receiving, by the first member, a fund receiving request initiated by the payee for the payer. In some implementations, the funds of the specified amount received by the payee come from a blockchain balance of the second member or a self-owned account of the second member. In some implementations, method 1700 further comprises performing a compliance check on a fund flow event corresponding to the request for fund flow. From 1702, method 1700 proceeds to 1704.

At 1704, a fund flow route between the first member and a second member corresponding to the payee in the blockchain is determined by the first member, where the fund flow route comprises the first member, the second member, and several relay members, and blockchain balances deposited by all members of the fund flow route at all anchor points of the blockchain are registered in a blockchain ledger of the blockchain. In some implementations, the associated anchor point exists between adjacent members in the fund flow route, a blockchain balance deposited by an upstream member in the adjacent members at the associated anchor point is greater than the specified amount, and the associated anchor point is set as a trusted anchor point by a downstream member. In some implementations, determining, by the first member, the fund flow route between the first member and a second member corresponding to the payee in the blockchain comprises: 1) initiating, by the first member, a route selection contract operation, wherein after the route selection contract operation takes effect, the fund flow route is determined based on a status of trustiness imposed by each member in each anchor point and a deposit status of a blockchain balance of each member at each anchor point registered in the blockchain ledger; and 2) after the fund flow contract operation takes effect, a blockchain balance deposited by the upstream member in the adjacent members at the associated anchor point is reduced by the specified amount, and a blockchain balance deposited by the downstream member at the associated anchor point is increased by the specified amount, uniformly changing the blockchain balances of all the members of the fund flow route registered in the blockchain ledger. From 1704, method 1700 proceeds to 1706.

At 1706, a fund flow contract operation is initiated by the first member. In some implementations, the fund flow contract operation in initiated by the first member comprises: 1) initiating, by the first member, the fund flow contract operation after obtaining the funds of the specified amount provided by the payer and depositing the funds of the specified amount in a blockchain balance of the first member or a self-owned account of the first member; or 2) initiating, by the first member, the fund flow contract operation based on credit of the payer before obtaining the funds of the specified amount provided by the payer. From 1706, method 1700 proceeds to 1708.

At 1708, in response to initiating the fund flow contract operation, the blockchain balances of all the members of the fund flow route registered in the blockchain ledger are uniformly changed, where the second member pays funds of the specified amount to the payee. After 1708, method 1700 can stop.

The described subject matter provides one or more technical effects/advantages over conventional methods for fund flow. For example, an advantage of the described subject matter is that the blockchain used for the fund flow possesses tamper-resistance and traceability features, so that a check result is sufficiently reliable and can be supplied to regulatory authorities for subsequent retrieval and checks. In some implementations, a fund flow route is determined based on the status of trustiness imposed by each member in each anchor point and a deposit status of a blockchain balance of each member at each anchor point registered in the blockchain ledger, thereby ensuring higher data security, tamper resistance, and trustworthiness.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, by a first member of a blockchain, a request for fund flow of a specified amount between a payer and a payee;
determining, by the first member, a fund flow route between the first member and a second member corresponding to the payee in the blockchain, wherein the fund flow route comprises the first member, the second member, and several relay members, and blockchain balances deposited by all members of the fund flow route at all anchor points of the blockchain are registered in a blockchain ledger of the blockchain;
initiating, by the first member, a fund flow contract operation; and
in response to initiating the fund flow contract operation, uniformly changing the blockchain balances of all the members of the fund flow route registered in the blockchain ledger, the second member paying funds of the specified amount to the payee.

2. The computer-implemented method of claim 1, wherein receiving, by the first member of the blockchain, the request for fund flow of the specified amount between the payer and the payee, comprises:
receiving, by the first member, a fund payment request initiated by the payer for the payee.

3. The computer-implemented method of claim 1, wherein receiving, by the first member of the blockchain, the request for fund flow of the specified amount between the payer and the payee, comprises:
receiving, by the first member, a fund receiving request initiated by the payee for the payer.

4. The computer-implemented method of claim 1, wherein:
the associated anchor point exists between adjacent members in the fund flow route, a blockchain balance deposited by an upstream member in the adjacent members at the associated anchor point is greater than the specified amount, and the associated anchor point is set as a trusted anchor point by a downstream member;
determining, by the first member, the fund flow route between the first member and a second member corresponding to the payee in the blockchain comprises:
initiating, by the first member, a route selection contract operation, wherein after the route selection contract operation takes effect, the fund flow route is determined based on a status of trustiness imposed by each member in each anchor point and a deposit status of a blockchain balance of each member at each anchor point registered in the blockchain ledger; and
after the fund flow contract operation takes effect, a blockchain balance deposited by the upstream member in the adjacent members at the associated anchor point is reduced by the specified amount, and a blockchain balance deposited by the downstream member at the associated anchor point is increased by the specified amount, uniformly changing the blockchain balances of all the members of the fund flow route registered in the blockchain ledger.

5. The computer-implemented method of claim 1, wherein initiating, by the first member, the fund flow contract operation comprises:
initiating, by the first member, the fund flow contract operation after obtaining the funds of the specified amount provided by the payer and depositing the funds of the specified amount in a blockchain balance of the first member or a self-owned account of the first member; or
initiating, by the first member, the fund flow contract operation based on credit of the payer before obtaining the funds of the specified amount provided by the payer.

6. The computer-implemented method of claim 1, wherein the funds of the specified amount received by the payee come from a blockchain balance of the second member or a self-owned account of the second member.

7. The computer-implemented method of claim 1, further comprising:
performing a compliance check on a fund flow event corresponding to the request for fund flow.

8. A non-transitory, computer-readable medium storing one or more instructions executable by a computer system to perform operations comprising:
receiving, by a first member of a blockchain, a request for fund flow of a specified amount between a payer and a payee;
determining, by the first member, a fund flow route between the first member and a second member corresponding to the payee in the blockchain, wherein the fund flow route comprises the first member, the second member, and several relay members, and blockchain balances deposited by all members of the fund flow route at all anchor points of the blockchain are registered in a blockchain ledger of the blockchain;
initiating, by the first member, a fund flow contract operation; and
in response to initiating the fund flow contract operation, uniformly changing the blockchain balances of all the members of the fund flow route registered in the blockchain ledger, the second member paying funds of the specified amount to the payee.

9. The non-transitory, computer-readable medium of claim 8, wherein receiving, by the first member of the blockchain, the request for fund flow of the specified amount between the payer and the payee, comprises:
receiving, by the first member, a fund payment request initiated by the payer for the payee.

10. The non-transitory, computer-readable medium of claim 8, wherein receiving, by the first member of the blockchain, the request for fund flow of the specified amount between the payer and the payee, comprises:
receiving, by the first member, a fund receiving request initiated by the payee for the payer.

11. The non-transitory, computer-readable medium of claim 8, wherein:
the associated anchor point exists between adjacent members in the fund flow route, a blockchain balance deposited by an upstream member in the adjacent members at the associated anchor point is greater than the specified amount, and the associated anchor point is set as a trusted anchor point by a downstream member;
determining, by the first member, the fund flow route between the first member and a second member corresponding to the payee in the blockchain comprises:
initiating, by the first member, a route selection contract operation, wherein after the route selection contract operation takes effect, the fund flow route is determined based on a status of trustiness imposed by each member in each anchor point and a deposit status of a blockchain balance of each member at each anchor point registered in the blockchain ledger; and
after the fund flow contract operation takes effect, a blockchain balance deposited by the upstream member in the adjacent members at the associated anchor point is reduced by the specified amount, and a blockchain balance deposited by the downstream member at the associated anchor point is increased by the specified amount, uniformly changing the blockchain balances of all the members of the fund flow route registered in the blockchain ledger.

12. The non-transitory, computer-readable medium of claim 8, wherein initiating, by the first member, the fund flow contract operation comprises:
initiating, by the first member, the fund flow contract operation after obtaining the funds of the specified amount provided by the payer and depositing the funds of the specified amount in a blockchain balance of the first member or a self-owned account of the first member; or
initiating, by the first member, the fund flow contract operation based on credit of the payer before obtaining the funds of the specified amount provided by the payer.

13. The non-transitory, computer-readable medium of claim 8, wherein the funds of the specified amount received by the payee come from a blockchain balance of the second member or a self-owned account of the second member.

14. The non-transitory, computer-readable medium of claim 8, further comprising:
performing a compliance check on a fund flow event corresponding to the request for fund flow.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a first member of a blockchain, a request for fund flow of a specified amount between a payer and a payee;
determining, by the first member, a fund flow route between the first member and a second member corresponding to the payee in the blockchain, wherein the fund flow route comprises the first member, the second member, and several relay members, and blockchain balances deposited by all members of the fund flow route at all anchor points of the blockchain are registered in a blockchain ledger of the blockchain;
initiating, by the first member, a fund flow contract operation; and
in response to initiating the fund flow contract operation, uniformly changing the blockchain balances of all the members of the fund flow route registered in the blockchain ledger, the second member paying funds of the specified amount to the payee.

16. The computer-implemented system of claim 15, wherein receiving, by the first member of the blockchain, the request for fund flow of the specified amount between the payer and the payee, comprises:
receiving, by the first member, a fund payment request initiated by the payer for the payee; or
receiving, by the first member, a fund receiving request initiated by the payee for the payer.

17. The computer-implemented system of claim 15, wherein:
the associated anchor point exists between adjacent members in the fund flow route, a blockchain balance deposited by an upstream member in the adjacent members at the associated anchor point is greater than the specified amount, and the associated anchor point is set as a trusted anchor point by a downstream member;
determining, by the first member, the fund flow route between the first member and a second member corresponding to the payee in the blockchain comprises:
initiating, by the first member, a route selection contract operation, wherein after the route selection contract operation takes effect, the fund flow route is determined based on a status of trustiness imposed by each member in each anchor point and a deposit status of a blockchain balance of each member at each anchor point registered in the blockchain ledger; and
after the fund flow contract operation takes effect, a blockchain balance deposited by the upstream member in the adjacent members at the associated anchor point is reduced by the specified amount, and a blockchain balance deposited by the downstream member at the associated anchor point is increased by the specified amount, uniformly changing the blockchain balances of all the members of the fund flow route registered in the blockchain ledger.

18. The computer-implemented system of claim 15, wherein initiating, by the first member, the fund flow contract operation comprises:
initiating, by the first member, the fund flow contract operation after obtaining the funds of the specified amount provided by the payer and depositing the funds of the specified amount in a blockchain balance of the first member or a self-owned account of the first member; or
initiating, by the first member, the fund flow contract operation based on credit of the payer before obtaining the funds of the specified amount provided by the payer.

19. The computer-implemented system of claim 15, wherein the funds of the specified amount received by the payee come from a blockchain balance of the second member or a self-owned account of the second member.

20. The computer-implemented system of claim 15, further comprising:
performing a compliance check on a fund flow event corresponding to the request for fund flow.
